(19) United States
(12) Patent Application Publication
(10) Pub. No.: US 2026/0031944 A1
(43) Pub. Date: Jan. 29, 2026

(54) SYSTEMS AND METHODS FOR CANCELING INTERFERENCE FROM CELLULAR BASE STATIONS

(71) Applicant: Massachusetts Institute of Technology, Cambridge, MA (US)

(72) Inventors: Binoy Kurien, Sudbury, MA (US); Michael Endres, Sudbury, MA (US); Bryan Ehlers, Waltham, MA (US); Jesmin Farzana Khan, Lexington, MA (US)

(73) Assignee: Massachusetts Institute of Technology, Cambridge, MA (US)

(21) Appl. No.: 18/661,418

(22) Filed: May 10, 2024

Related U.S. Application Data
(60) Provisional application No. 63/502,060, filed on May 12, 2023.

(51) Int. Cl. H04L 5/00

(52) U.S. Cl. CPC H04L 5/0048

(57) ABSTRACT

The techniques described herein relate to systems, apparatus, articles of manufacture, and methods for canceling interference from cellular base stations. An example method comprising receiving a wireless signal on a plurality of antennas at a wireless receiver, detecting an allocation and modulation of data carrying and reference signal components of the wireless signal on resources of the plurality of antennas, the resources comprising at least one of time, frequency, or spatial resources of the plurality of antennas, detecting a received symbol in the wireless signal based on the detected allocation and modulation, reconstructing, using the received symbol, a denoised symbol representing an estimate of a contribution of an interferer signal at the wireless receiver, the contribution of the interferer signal isolated from all other sources, subtracting the denoised symbol from the received symbol on an antenna-by-antenna basis to generate a residual wireless signal, and outputting the residual wireless signal.

### RELATED APPLICATION

This patent claims priority under 35 U.S.C. § 119(e) to U.S. Provisional Application No. 63/502,060, titled “ALGORITHM FOR CANCELING INTERFERENCE FROM 5G NEW RADIO BASE STATIONS,” filed on May 12, 2023, which is hereby incorporated by reference herein in its entirety.

### GOVERNMENT SUPPORT

This invention was made with government support under FA8702-15-D-0001 awarded by the U.S. Air Force. The government has certain rights in this invention.

### FIELD

The techniques described herein relate generally to wireless communications and, more particularly, to systems and methods for canceling interference from cellular base stations.

### BACKGROUND

5G is the fifth generation of wireless cellular technology. 5G New Radio (NR) base stations may emit wireless communication signals in a variety of frequency bands referred to as low-band, mid-band, and high-band. One or more of these bands may also be used by non-5G systems, which then may incur unwanted interference from the 5G base stations.

### SUMMARY

In accordance with the disclosed subject matter, systems, apparatus, articles of manufacture, and methods are provided for canceling interference from cellular base stations.

Some embodiments relate to a method for reducing cellular interference in wireless communication signals. The method comprising: receiving a wireless signal on a plurality of antennas at a wireless receiver; detecting an allocation and modulation of data carrying and reference signal components of the wireless signal on resources of the plurality of antennas, the resources comprising at least one of time, frequency, or spatial resources of the plurality of antennas; detecting a received symbol in the wireless signal based on the detected allocation and modulation; reconstructing, using the received symbol, a denoised symbol representing an estimate of a contribution of an interferer signal at the wireless receiver, the contribution of the interferer signal isolated from all other sources; subtracting the denoised symbol from the received symbol on an antenna-by-antenna basis to generate a residual wireless signal; and outputting the residual wireless signal.

Some embodiments relate to at least one computer-readable storage medium storing processor-executable instructions that, when executed by at least one hardware processor, cause the at least one hardware processor to perform a method for reducing interference in wireless communication signals. The method comprising: receiving a wireless signal on a plurality of antennas at a wireless receiver; detecting an allocation and modulation of data carrying and reference signal components of the wireless signal on resources of the plurality of antennas, the resources comprising at least one of time, frequency, or spatial resources of the plurality of antennas; detecting a received symbol in the wireless signal based on the detected allocation and modulation; reconstructing, using the received symbol, a denoised symbol representing an estimate of a contribution of an interferer signal at the wireless receiver, the contribution of the interferer signal isolated from all other sources; subtracting the denoised symbol from the received symbol on an antenna-by-antenna basis to generate a residual wireless signal; and outputting the residual wireless signal.

Some embodiments relate to a system for reducing interference in wireless communication signals, the system comprising: at least one hardware processor; and at least one computer-readable storage medium storing processor-executable instructions that, when executed by the at least one hardware processor, cause the at least one hardware processor to perform a method. The method comprising: receiving a wireless signal on a plurality of antennas at a wireless receiver; detecting an allocation and modulation of data carrying and reference signal components of the wireless signal on resources of the plurality of antennas, the resources comprising at least one of time, frequency, or spatial resources of the plurality of antennas; detecting a received symbol in the wireless signal based on the detected allocation and modulation; reconstructing, using the received symbol, a denoised symbol representing an estimate of a contribution of an interferer signal at the wireless receiver, the contribution of the interferer signal isolated from all other sources; subtracting the denoised symbol from the received symbol on an antenna-by-antenna basis to generate a residual wireless signal; and outputting the residual wireless signal.

The foregoing summary is not intended to be limiting. Moreover, various aspects of the present disclosure may be implemented alone or in combination with other aspects.

### BRIEF DESCRIPTION OF FIGURES

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1 is a schematic illustration of an example radar detection system including a wireless signal cancellation module to reduce signal interference from interferers, in accordance with some embodiments of the technology described herein.

FIG. 2 is a block diagram of an example implementation of the wireless signal cancellation module of FIG. 1, in accordance with some embodiments of the technology described herein.

FIG. 3 is a block diagram of an example signal synchronization block (SSB), in accordance with some embodiments of the technology described herein.

FIG. 4 is a block diagram of an example implementation of a portion of the wireless signal cancellation module of FIG. 2 for cancellation of primary synchronization signal (PSS) and secondary synchronization signal (SSS) signal components, in accordance with some embodiments of the technology described herein.

FIG. 5 is a block diagram of an example implementation of another portion of the wireless signal cancellation module of FIG. 2 for cancellation of physical broadcast channel (PBCH) signal components, in accordance with some embodiments of the technology described herein.

FIG. 6 shows an example simulation scenario, in accordance with some embodiments of the technology described herein.

FIG. 7 shows plots for example received, reconstructed, and residual wireless signals, in accordance with some embodiments of the technology described herein.

FIG. 8 shows plots for pre-suppression, post-suppression, and interference-free wireless signals, in accordance with some embodiments of the technology described herein.

FIG. 9 is a flowchart representative of an example process that may be performed and/or example machine-readable instructions that may be executed by processor circuitry to implement the wireless signal cancellation module of FIGS. 1 and/or 2 to reduce signal interference from an interferer emitter, in accordance with some embodiments of the technology described herein.

FIG. 10 is a flowchart representative of an example process that may be performed and/or example machine-readable instructions that may be executed by processor circuitry to implement the wireless signal cancellation module of FIGS. 1 and/or 2 to detect a received symbol, in accordance with some embodiments of the technology described herein.

FIG. 11 is an example electronic platform structured to execute the machine-readable instructions of FIGS. 9 and/or 10 to implement the wireless signal cancellation module of FIGS. 1 and/or 2, according to some embodiments.

### DETAILED DESCRIPTION

The inventors have developed techniques for canceling and/or otherwise reducing interference from cellular base stations. A base station may refer to a stationary transceiver that serves as a hub for connectivity of wireless device communication in a wireless network including client devices referred to as “user equipment” or “UE”. Examples of UEs include mobile phones (e.g., smartphones), Internet-of-Things (IoT) devices, and other cellular-enabled devices such as laptop computers, tablet computers, and vehicles. For example, in some embodiments, a fifth generation wireless cellular technology (“5G”) New Radio (NR) base station (referred to as a “5G base station” or “gNodeB (gNB)”) may emit 5G wireless signals in frequency bands occupied by other non-5G systems. An example non-5G system may be a radar system including a wireless receiver for tracking a target object. The radar system may receive the 5G wireless signals and tracking signals (for the target object) on one or more antennas of the wireless receiver. In some such embodiments, the radar system may be configured, using the published structure of the 5G downlink waveform, to adaptively reconstruct and cancel the 5G wireless signals on a per-antenna basis.

Advantageously, this cellular interference rejection restores sensitivity to signals-of-interest and thereby preserves, for example, target detection range in the case of a co-channel radar and/or sensor, or link throughput in the example of a co-channel communication system. Although the above example references a radar system, the techniques developed by the inventors are applicable to other radiofrequency (RF) systems that may be impacted by cellular signal interference (e.g., 5G wireless signal interference). Additionally, the techniques developed by the inventors are applicable to RF systems that may be impacted by signal interference from wireless signals generated in accordance with orthogonal frequency-division multiplexing (OFDM).

The inventors have recognized that RF systems, such as non-cellular RF systems (e.g., non-5G RF systems), operating in frequency bands associated with cellular base stations (e.g., 5G cellular base stations) can be adversely affected by interference from these cellular base stations. These cellular base stations may be referred to as “interferer base stations,” “interferer emitters,” “interferer transceivers,” or “interferer wireless devices” because they may cause interference with RF signal processing operations of the non-5G RF systems. For example, a non-5G RF system, such as a radar system, operating in a 5G associated frequency band may experience unwanted interference from 5G base stations. Example 5G frequency bands include the n28 frequency band of 703-803 Megahertz (MHz), the n40 frequency band of 2.3-2.4 Gigahertz (GHz), the n41 frequency band of 2.496-2.690 GHz, and the n77 frequency band of 3.3-4.2 GHz. For example, a non-5G RF system occupying spectrum that is either overlapping with or adjacent to 5G allocations may experience interference and such interference may adversely affect operation of the RF system and/or another system receiving data processed by the RF system.

The inventors have also recognized that conventional approaches to mitigating cellular interference from cellular base stations have several shortcomings. First, the nulling capability of conventional RF systems is limited to the spatial degrees-of-freedom (DoF) of such systems. For example, conventional RF systems that employ adaptive beamforming can form spatial beampatterns that null interfering emitters (e.g., cellular base stations) while protecting the signal-of-interest reflected by a target (e.g., a target object). However, this beamforming approach is fundamentally limited in the sense that an RF system with M sub-arrays can null only up to M−1 interfering signals in general. In such an example, such an RF system has a finite number M spatial DoF and each interfering signal that is nulled consumes one of these DoF. A second shortcoming is that adaptive beamforming relies on sufficient angular separation between signal-of-interest(s) and interferer(s). Otherwise, null(s) formed in the direction(s) of the interferer(s) will also suppress the signal-of-interest(s).

A third shortcoming of conventional RF systems is that by using one or more spatial DoF to null interfering emitters, such RF systems track targets with reduced efficiency. For example, by nulling up to M−1 interfering signals, conventional RF systems are limited in their ability to increase the gain for the target tracking signals and, in some instances, may be unable to track the target if such tracking signals are substantially attenuated due to environment conditions.

The inventors have developed a new wireless signal cancellation module to overcome these problems with conventional RF systems. The wireless signal cancellation module may be configured to cancel wireless signals by leveraging the published or known physical layer structures of the wireless signals to be canceled. For example, the wireless signal cancellation module may receive a 5G orthogonal frequency-division multiplexing (OFDM) waveform from one or more interferer emitters (or interfering emitters). The wireless signal cancellation module may reconstruct a denoised 5G OFDM waveform in accordance with the published physical layer structure of the 5G OFDM waveform. The wireless signal cancellation module may individually excise contributions from the interferer emitter(s) to each spatial channel by subtracting the denoised 5G OFDM waveform from the received mixture of wireless signals captured on these channels. For example, the wireless signal cancellation module may reconstruct denoised portions of the 5G OFDM waveform, such as the physical downlink shared channel (PDSCH) and physical downlink control channel (PDCCH) allocations, and subtract the denoised PDSCH and PDCCH portions from the received mixture of wireless signals captured on these channels. Advantageously, by individually excising the 5G OFDM waveform's contribution to each spatial channel, the wireless signal cancellation module preserves the wireless receiver's spatial DoF for mitigating other (potentially unstructured) interferers.

A “denoised waveform” may refer to a waveform of a specific interfering emitter (or interferer emitter) as the component of the overall received signal multiplex (e.g., signal mixture) at a receiver that is due to that particular emitter in isolation from all other components of the multiplex (including other interfering emitter(s), thermal noise in the receiver, and the signal-of-interest). In a 5G environment, the denoised waveform may comprise both what was intended to be transmitted by the 5G base station and how the propagation environment (also known as the “channel”) perturbed the transmitted waveform on its way to the non-5G receiver. Advantageously, by detecting what was transmitted as well as estimating the channel in order to construct the denoised waveform, the wireless signal cancellation module may subtract the denoised waveform to improve sensitivity to the signal-of interest of the non-5G system while preserving the system's spatial DoF.

A “denoised symbol” may refer to a symbol of a specific interfering emitter (or interferer emitter) as the component of the overall received signal multiplex (e.g., signal mixture) at a receiver that is due to that particular emitter in isolation from all other components of the multiplex (including other interfering emitter(s), thermal noise in the receiver, and the signal-of-interest). In a 5G environment, the denoised symbol may comprise both what was intended to be transmitted by the 5G base station and how the propagation environment (also known as the “channel”) perturbed the transmitted symbol on its way to the non-5G receiver. Advantageously, by detecting what was transmitted as well as estimating the channel in order to construct the denoised symbol, the wireless signal cancellation module may subtract the denoised symbol to improve sensitivity to the signal-of interest of the non-5G system while preserving the system's spatial DoF.

In some embodiments, the wireless signal cancellation module executes and/or otherwise performs a series of inferential and signal processing operations. The wireless signal cancellation module may detect the signaling state of the downlink 5G waveform, including the PDSCH and PDCCH allocations, PDSCH demodulation reference signal (DMRS) reference symbol layout, modulation, and layer activation using a maximum likelihood approach. The wireless signal cancellation module may demodulate the individual OFDM symbols, estimate the propagation channel, reconstruct denoised waveforms on each spatial channel, and excise the denoised waveforms on a per-channel basis.

While the above examples reference 5G NR wireless signals, future generations of cellular communications standards (e.g., 6G, 7G, etc.) may feature waveform structure similar to that in the 5G NR standard. Moreover the technology developed by the inventors is agnostic to the signal-of-interest to be protected from interference. Hence the technology, such as the wireless signal cancellation module disclosed herein, may be configured and/or used to protect a broad class of RF systems against interference from a class of cellular base stations extending well beyond 5G NR base stations.

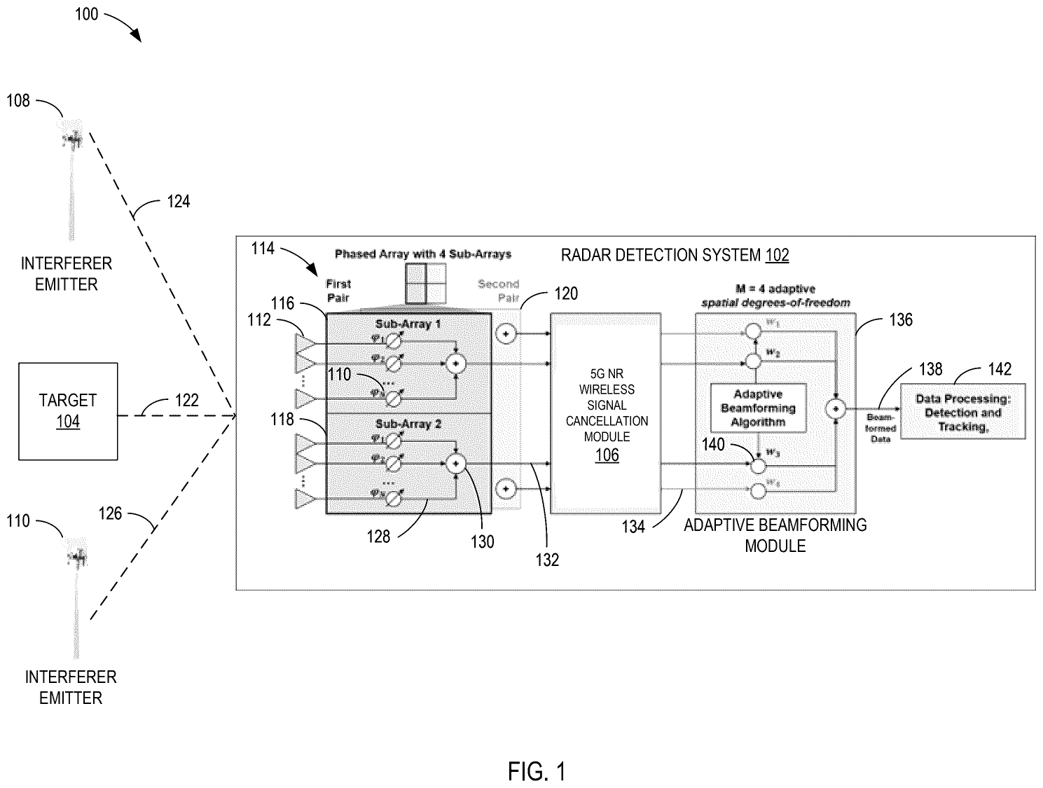

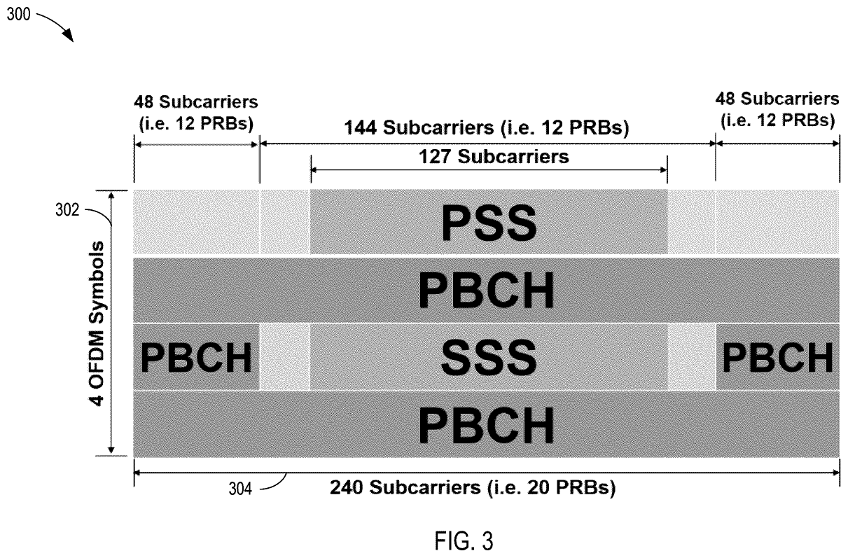

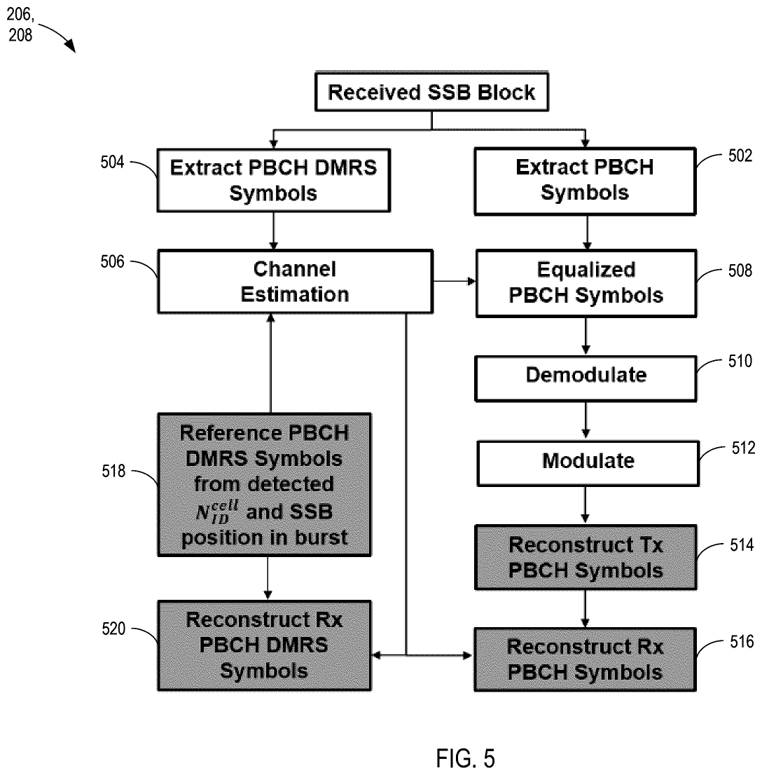

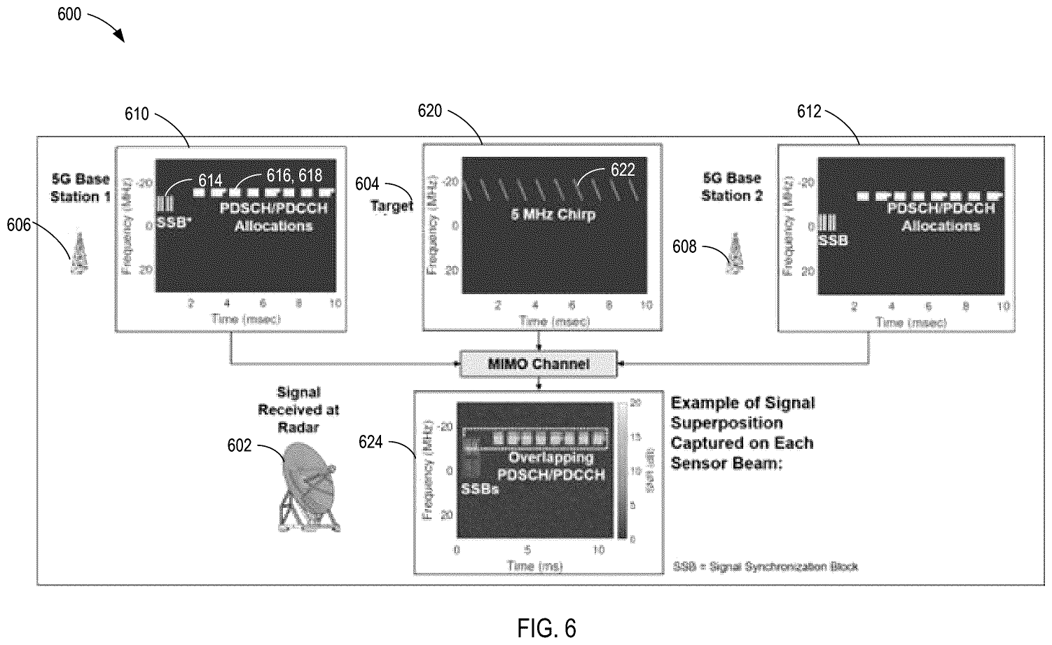

In some embodiments, the techniques developed by the inventors provide for systems, apparatus, articles of manufacture, and methods for reducing interference in wireless communication systems. An example method comprises receiving a wireless signal (e.g., the RF signal from the target shown in FIG. 1, the RF signal from the first interferer emitter shown in FIG. 1, the RF signal from the second interferer emitter shown in FIG. 1) on a plurality of antennas (e.g., the antennas shown in FIG. 1, the sub-arrays shown in FIG. 1) at a wireless receiver (e.g., the radar receiver of the radar detection system shown in FIG. 1), detecting an allocation and modulation of data carrying (e.g., PDSCH signal components shown in FIG. 6) and reference signal components (e.g., PBCH DMRS symbols shown in FIG. 5) of the wireless signal on resources of the plurality of antennas, the resources comprising at least one of time, frequency, or spatial resources of the plurality of antennas, detecting a received symbol (e.g., a PSS symbol shown in FIG. 3, a PBCH symbol shown in FIG. 3, an SSS symbol shown in FIG. 3, a PDSCH symbol, a PDCCH symbol) in the wireless signal based on the detected allocation and modulation, reconstructing, using the received symbol, a denoised symbol (e.g., the reconstructed received (RX) PBCH symbols shown in FIG. 5) representing an estimate of a contribution of an interferer signal (e.g., the RF waveforms transmitted by and/or emitted from the interferer emitters shown in FIG. 1) at the wireless receiver, the contribution of the interferer signal isolated from all other sources, subtracting the denoised symbol from the received symbol on an antenna-by-antenna basis to generate a residual wireless signal (e.g., the residual wireless signal shown in FIG. 1), and outputting the residual wireless signal.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

Turning to the figures, the illustrated example of FIG. 1 is a schematic illustration of an example wireless communication environment 100 including an example wireless receiver system 102. In this example, the wireless receiver system 102 is a radar detection system tracking movement of a target 104. Alternatively, the wireless receiver system 102 may be a Wireless Fidelity (Wi-Fi) access point. The radar detection system 102 of this example includes and/or otherwise implements a wireless signal cancellation module 106 to cancel and/or otherwise reduce wireless signal interference from interferer emitters 108, 110 when tracking the target 104.

In the illustrated example, the radar detection system 102 is configured to track movement of the target 104 using radio detection and ranging (RADAR) techniques. For example, the radar detection system 102 may be configured to use radio waves to determine the distance, direction, and/or radial velocity of the target 104 relative to the radar detection system 102. As shown, the radar detection system 102 may radiate, using one or more of its antennas 112, increased energy in its beams (e.g., gain) to track the target 104. For example, the radar detection system 102 may form beam patterns with high gain towards the target 104 while putting low gains on interference from other sources, such as interference from the interferer emitters 108, 110.

The target 104 of this example is a moveable target. The target 104 may be a vehicle. Example vehicles include aerial vehicles, land vehicles, and marine vehicles. Example aerial vehicles include manned aircraft (e.g., commercial planes, private planes, military aircraft) and unmanned aircraft (e.g., drones). Example land vehicles include automobiles (e.g., passenger sedans and sports utility vehicles (SUVs), buses, trains, and trucks. Example marine vehicles include boats, ferries, ships, and vessels. Although one target is shown, the radar detection system 102 may additionally track multiple targets.

The interferer emitters 108, 110 of this example are cellular emitters. The cellular emitters may be implemented by one or more base stations (e.g., wireless base stations). The cellular emitters may implement a macrocell (also referred to as a “macrosite”). A macrocell is a network cell that can be implemented by a relatively high-range, high-power wireless base station that can send and/or receive radio signals through large towers (referred to as “cell towers” or “cellular towers”) and antennas. For example, a cell tower implementing a macrocell can be relatively tall (e.g., 50 feet, 100 feet, 200 feet, etc.) and provide cellular coverage for miles.

The cellular emitters may implement a small cell, which can be implemented by a cellular base station with a physical footprint smaller than a cell tower. A small cell can send and/or receive radio signals to improve wireless network connectivity in specific areas. A small cell requires less power than a cell tower but has a smaller coverage area (e.g., a range of 300 feet to 8000 feet) than a cell tower.

The interferer emitters 108, 110 of this example are 5G cellular emitters. For example, a first interferer emitter 108 may be a first 5G wireless base station (e.g., a first gNB) having one or more antennas. Furthering the example, a second interferer emitter 110 may be a second 5G wireless base station (e.g., a second gNB) having one or more antennas. In some such embodiments, the interferer emitters 108, 110 emit downlink 5G NR signals, which may form the cellular signal interference described herein.

In some embodiments, the first interferer emitter 108 and/or the second interferer emitter 110 may be terrestrial interferer emitters. For example, the first interferer emitter 108 and/or the second interferer emitter 110 may be a gNB installed on a tower or indoors (e.g., a small cell deployment).

In some embodiments, the first interferer emitter 108 and/or the second interferer emitter 110 may be non-terrestrial interferer emitters. For example, the first interferer emitter 108 and/or the second interferer emitter 110 may be a gNB installed on a satellite (e.g., a low Earth orbit (LEO) satellite).

In some embodiments, the first interferer emitter 108 and/or the second interferer emitter 110 may be non-terrestrial interferer emitters may be stationary interferer emitters. For example, the first interferer emitter 108 and/or the second interferer emitter 110 may be a gNB installed at a fixed location (e.g., a tower, an indoor deployment).

In some embodiments, the first interferer emitter 108 and/or the second interferer emitter 110 may be non-terrestrial interferer emitters may be mobile interferer emitters. For example, the first interferer emitter 108 and/or the second interferer emitter 110 may be a gNB installed on a vehicle, such as a land vehicle (e.g., an automobile, a truck), a marine vehicle (e.g., a ship, a boat), an aerial vehicle (e.g., an aircraft), or a space vehicle (e.g., a LEO satellite).

Although the interferer emitters 108, 110 of this example are 5G cellular emitters, one(s) of the interferer emitters 108, 110 may be implemented by future generation cellular technologies. For example, one(s) of the interferer emitters 108, 110 may be 6G, 7G, etc., cellular emitters.

The radar detection system 102 of the illustrated example may be impacted by 5G cellular interference from the interferer emitters 108, 110. In this example, the radar detection system 102 does not have an active 5G wireless connection with either of the interferer emitters 108, 110.

As shown, the radar detection system 102 includes a plurality of antennas 112. The antennas 112 are omnidirectional antennas. Alternatively, one(s) of the antennas 112 may be directional or semi-directional antennas.

The antennas 112 of this example are arranged in a phased array 114. As shown, the phased array 114 includes four sub-arrays 116, 118, 120. A first pair of the sub-arrays 116, 118, 120 are shown as Sub-Array 1 116 and Sub-Array 2 118. A second pair of the sub-arrays 116, 118, 120 are not shown for enhanced drawing clarity.

The antennas 112 receive radiofrequency (RF) waveforms 122, 124, 126 impinging on the sub-arrays 116, 118, 120. The RF waveforms 122, 124, 126 may include and/or be representative of signals (e.g., tracking signals) reflected from the target 104. For example, RF waveforms 122 may be tracking signals. The tracking signals may be RADAR signals. The RF waveforms 122, 124, 126 may include interference signals from the interferer emitters 108, 110. For example, RF waveforms 124, 126 may be interferer signals. RF waveforms 124, 126 may also be referred to as interference signals. The interferer signals may be cellular signals, such as 5G cellular signals.

The sub-arrays 116, 118, 120 convert the RF waveforms 122, 124, 126 into digitized RF signals 128. The digitized RF signals 128 are digital representations of the RF waveforms 122, 124, 126. The sub-arrays 116, 118, 120 combine, via an addition module 130, the digitized RF signals 128 for output to the wireless signal cancellation module 106. Outputs from the addition module 130 are digitized RF signals 132. For example, the digitized RF signals 132 may be digitized representations of RF waveforms (e.g., digitized RF waveforms).

The wireless signal cancellation module 106 receives the combined digitized RF signals 128 from one(s) of the sub-arrays 116, 118, 120. As explained further below, the wireless signal cancellation module 106 may detect an allocation and modulation of data carrying and reference signal components of the digitized RF signals 128 on resources of the plurality of antennas 112. The resources may include at least one of time, frequency, or spatial resources of the plurality of antennas 112. The wireless signal cancellation module 106 may detect a received symbol in the digitized RF signals 128 based on the detected allocation and modulation. The wireless signal cancellation module 106 may reconstruct, using the received symbol, a denoised symbol representing an estimate of a contribution of an interferer signal (e.g., RF waveforms 124, 126 from the interferer emitters 108, 110) at the radar detection system 102. In this example, the contribution of the interferer signal is isolated from all other sources of interference. The wireless signal cancellation module 106 may subtract the denoised symbol from the received symbol on an antenna-by-antenna basis to generate one or more residual wireless signals 134. The residual wireless signals 134 of this example are digitized RF signals. The digitized RF signals may be digitized RF signals with suppressed 5G cellular signal components.

The wireless signal cancellation module 106 may generate the residual wireless signals 134 by suppressing (e.g., highly attenuating) the 5G cellular signal components on each sub-array 116, 118, 120. The 5G cellular signal components may include the data carrying and reference signal components of 5G wireless communications. Advantageously, the wireless signal cancellation module 106 may suppress 5G cellular signal components from the interferer emitters 108, 110 while not being communicatively synchronized to the interferer emitters 108, 110. The wireless signal cancellation module 106 may suppress the 5G cellular signal components by reconstructing denoised 5G cellular signal components of the 5G cellular signal received by the antennas 112 and subtracting the denoised 5G cellular signal components from the received 5G cellular signal components.

The residual wireless signals 134 are digitized RF signals and correspond to outputs from the sub-arrays 116, 118, 120. For example, a first one of the residual wireless signals 134 may correspond to an output from the first sub-array 116. As shown, the wireless signal cancellation module 106 outputs the residual wireless signals 134 to an adaptive beamforming module 136 for processing.

The adaptive beamforming module 136 may be configured to control operation of the antennas 112. For example, the adaptive beamforming module 136 may be configured to direct and/or change power of one(s) of the antennas 112 for tracking the target 104. The adaptive beamforming module 136 may generate beamformed data 138 using the residual wireless signals 134. The beamformed data 138 may be a weighted combination of the residual wireless signals 134, where weights 140 (identified by w₁, w₂, w₃, and w₄) are designed to preserve the signal-of-interest while further rejecting the interference from the interferer emitters 108, 110 to output a higher fidelity representation of the target signal. The target signal in this example may be the digitized representation of the RF waveforms 122 reflected from the target 104 and received by one(s) of the antennas 112.

The adaptive beamforming module 136 outputs the beamformed data 138 to a data processing module 142 for processing. The data processing module 142 may be configured to execute detection and/or tracking operations in connection with one or more targets, such as the target 104.

In the illustrated example, the radar detection system 102 implements a receiver. The receiver is a wireless receiver. The wireless receiver is a radar receiver. In some embodiments, one or more components of the radar detection system 102 form the radar receiver. For example, the radar receiver may be implemented by and/or include the antennas 112. In some embodiments, the radar receiver may be implemented by and/or include the antennas 112 and the wireless signal cancellation module 106. In some embodiments, the radar receiver may be implemented by and/or include the antennas 112, the wireless signal cancellation module 106, and the adaptive beamforming module 136. In some embodiments, the radar receiver may be implemented by and/or include the antennas 112, the wireless signal cancellation module 106, the adaptive beamforming module 136, and the data processing module 142.

While an example implementation of the radar detection system 102 is depicted in FIG. 1, other implementations are contemplated. For example, one or more blocks, components, functions, etc., of the radar detection system 102 may be combined or divided in any other way. The radar detection system 102 of the illustrated example may be implemented by hardware alone, or by a combination of hardware, software, and/or firmware. For example, the radar detection system 102 may be implemented by one or more analog or digital circuits (e.g., comparators, operational amplifiers, etc.), one or more hardware-implemented state machines, one or more programmable processors (e.g., central processing units (CPUs), digital signal processors (DSPs), field programmable gate arrays (FPGAs), graphics processing units (GPUs), etc.), one or more network interfaces (e.g., network interface circuitry, network interface cards (NICs), smart NICs, etc.), one or more application specific integrated circuits (ASICs), one or more memories (e.g., non-volatile memory, volatile memory, etc.), one or more mass storage disks or devices (e.g., hard-disk drives (HDDs), solid-state disk (SSD) drives, etc.), etc., and/or any combination(s) thereof. For example, the wireless signal cancellation module 106 may be implemented by one or more CPUs. Alternatively, the wireless signal cancellation module 106 may be implemented by one or more DSPs, FPGAs, GPUs, and/or ASICs.

In some embodiments, the radar detection system 102, or portion(s) thereof, may be implemented by a system on a chip or system-on-chip (SoC). An SoC is an integrated circuit design that combines elements of an electronic device onto a single chip instead of using separate components. For example, an SoC may include and/or incorporate within itself one or more programmable processors, input and output (I/O) ports, memory, analog input blocks, analog output blocks, etc., and/or any combination(s) thereof. For example, the radar detection system 102 may be implemented by a single platform and integrates an entire electronic device (or portion(s) thereof), such as a receiver device, onto the platform.

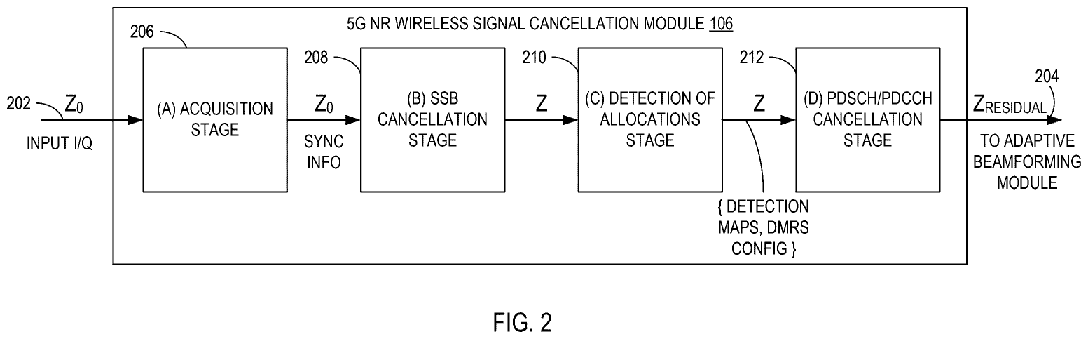

FIG. 2 is a block diagram of an example implementation of the wireless signal cancellation module 106 of FIG. 1. While an example implementation of the wireless signal cancellation module 106 is depicted in FIG. 2, other implementations are contemplated. For example, one or more blocks, components, functions, etc., of the wireless signal cancellation module 106 shown in FIG. 2 may be combined or divided in any other way.

In some embodiments, the wireless signal cancellation module 106 implements a measurement model in accordance with orthogonal frequency division multiplexing (OFDM) to cancel 5G signal components from an RF signal. For example, the wireless signal cancellation module 106 may implement an OFDM-based model because 5G New Radio (NR) uses (OFDM) as its modulation. In such an example, the wireless signal cancellation module 106 may reconstruct 5G interference in its OFDM resource grid. Accordingly, the measurement model implemented by the wireless signal cancellation module 106 may be specified in accordance with a resource-grid representation. Assume gNodeB g spatially multiplexes the downlink over L layers. The non-5G system may be denoted as the victim. For example, the radar detection system 102 of FIG. 1 may be the victim. The victim's receiver (e.g., wireless receiver) captures the downlink on R spatial channels, so the R-length vector z representing the received signal aligned to the g-th gNodeB's resource grid at subcarrier k (in frequency) and symbol l (in time) may be written as:

$${z}_{kl}^{g} = {H}_{kl}^{g} {W}_{kl}^{g} {x}_{kl}^{g} + {b}_{kl}^{g} + {n}_{kl}^{g} , \qquad Equation ( 1 )$$

where

$${x}_{kl}^{g}$$

is the L-by-1 vector of transmitted symbols,

$${W}_{kl}^{g}$$

is the T-by-L precoding matrix, and

$${H}_{kl}^{g}$$

is the R-by-T multiple-input multiple-output (MIMO) channel matrix mapping the precoded symbols transmitted on T antennas to the received symbols captured on R receive channels. Interference in the environment (e.g., the wireless communication environment 100 of FIG. 1), including other co-channel gNodeBs, is given by

$${b}_{kl}^{g} ,$$

and the measurement noise is given by

$${n}_{kl}^{g} .$$

Like the User Equipment (UE) the gNodeB is serving, the victim's receiver need not estimate

$${H}_{kl}^{g} and {W}_{kl}^{g}$$

individually in order to recover

$${x}_{kl}^{g} ;$$

rather an estimate of their matrix product may be sufficient. Hence may be convenient in several instances below to consolidate the MIMO channel and precoding into a single mixing matrix

$${M}_{kl}^{g} = {H}_{kl}^{g} {W}_{kl}^{g} ,$$

which describes the end-to-end mapping of the L transmit layers to the R channels at the receiver. The example of Equation (2) below may represent this case:

$${z}_{kl}^{g} = {M}_{kl}^{g} {x}_{kl}^{g} + {b}_{kl}^{g} + {n}_{kl}^{g} , \qquad Equation ( 2 )$$

In the single-layer case (e.g., L=1), the mixing matrix

$${M}_{kl}^{g}$$

reduces to an R×1 column vector denoted hereafter as

$${m}_{kl}^{g}$$

where applicable.

In some embodiments, for unique symbol recovery, some example necessary conditions may be present. Given an estimate of

$${M}_{kl}^{g} ,$$

unambiguous recovery of arbitrary transmitted symbol

$${x}_{kl}^{g}$$

from the measurements

$${z}_{kl}^{g}$$

requires the R-by-L mixing matrix

$${M}_{kl}^{g}$$

to be full rank. This then implies that the number of gNodeB-transmitted layers L must not exceed the channel rank, i.e., rank

$$( {H}_{kl}^{g} ) ,$$

and hence by extension the number of victim user's receive channels R. The channel rank condition implies that the gNodeB-to-victim channel needs to have a spatially uncorrelated component due, for example, to significant scattering in the environment.

Returning to the illustrated example of FIG. 2, the nominal input to the wireless signal cancellation module 106 is an input 202 (identified by Z₀). The input 202 of this example is R-channel baseband I/Q data in which each channel nominally corresponds to a distinct victim antenna. For example, the input 202 may be the digitized RF signals 132 output from the addition module 130 of the sub-arrays 116, 118, 120. The nominal output is filtered R-channel I/Q data 204 (identified by Z_{RESIDUAL}) in which 5G interference has been suppressed through cancellation. For example, the filtered R-channel I/Q data 204 may be one or more of the residual wireless signals 134 of FIG. 1.

In some embodiments, this suppression capability is nominally hosted on a victim user platform (e.g., the radar detection system 102 of FIG. 1) that cannot rely upon the stateful information on downlink configuration and allocation available to a UE, due for example to scheduling and instantaneous bandwidth constraints. Hence over the course of the four stages depicted in FIG. 2, the wireless signal cancellation module 106 may detect the configuration and time/frequency location of the following signal elements expected to be typical in the 5G NR downlink: 1) Signal Synchronization Block (SSB), which provides UEs a signaling mechanism of acquiring the downlink; 2) Physical Downlink Control Channel (PDCCH), which is used to transmit control information; 3) Physical Downlink Shared Channel (PDSCH), which is used to transmit user data to specific users and then uses this detected configuration to reconstruct and cancel these elements independently. For example, SSB may be the synchronization carrying signal component of a received wireless signal, such as the 5G downlink signal. PDCCH may be the control carrying signal component of a received wireless signal, such as the 5G downlink signal. PDSCH may be the data carrying signal component (e.g., the user data carrying signal component) of a received wireless signal, such as the 5G downlink signal.

Demodulation Reference Signals (DMRS) embedded within these components (e.g., SSB, PDCCH, PDSCH) enable the MIMO channel estimation required for their reconstruction. Detail on the construction of these signal elements can be found in standard references on the 5G NR waveform. PDCCH features a single, fixed pattern of DMRS resource elements, which is distinct from the highly-configurable DMRS embedded in PDSCH. The wireless signal cancellation module 106 leverages the distinct patterns to discriminate between PDSCH and PDCCH in the resource grid. For example, DMRS may be the reference signal components of a received wireless signal, such as the 5G downlink signal.

In the illustrated example of FIG. 2, the block diagram of the wireless signal cancellation module 106 may be representative of a workflow including a series of stages 206, 208, 210, 212. The stages 206, 208, 210, 212 may implement the above-described measurement model. The stages 206, 208, 210, 212 may be stages of a pipeline (e.g., a processing pipeline) implemented by hardware alone or a combination of hardware, software, and/or firmware.

The first stage 206 of the illustrated example is an acquisition stage. The second stage 208 is an SSB cancellation stage. The third stage 210 is a detection of allocations stage. The fourth stage is a PDSCH/PDCCH cancellation stage. The workflow may implement an algorithm, such as an algorithm for suppressing 5G interference in wireless signals. Hereafter, the input signal before SSB suppression is denoted as Z₀, the intermediate output after SSB suppression as z, and the final output after PDSCH/PDCCH cancellation as Z_{RESIDUAL} as it represents the interference-mitigated input into existing victim processing. The four stages 206, 208, 210, 212 of the workflow are described in turn below.

In the illustrated example, the first stage 206 is executed to align the wireless signal cancellation module 106 to the resource grid of the 5G downlink signal in dimensions of time and frequency in order to reconstruct the 5G downlink signal. For this purpose, the wireless signal cancellation module 106 leverages the periodic Signal Synchronization (SS) Bursts, which are beacon signals emitted by 5G gNodeBs to allow User Equipment (UE) to acquire the downlink. For example, the SS Bursts may be beacon signals emitted by the interferer emitters 108, 110 of FIG. 1. Each SS Burst consists of a series of S Signal Synchronization Blocks (SSBs) (where S can range from 4 to 8 in 5G NR Band n78), which may be independently beamformed to span a desired cellular coverage region. Each block itself consists of 4 OFDM symbols comprising the following elements: 1) Primary Synchronization Signal (PSS); 2) Secondary Synchronization Signal (SSS); 3) Physical Broadcast Channel (PBCH); 4) Demodulation Reference Signal (DMRS).

The time/frequency placement of these elements in the SSB is shown in FIG. 3. FIG. 3 is a block diagram of an example SSB 300. As shown, the vertical axis is time in units of OFDM symbols 302 and the horizontal axis is frequency in units of subcarriers 304.

The SSB 300 includes 4 OFDM symbols 302 over 240 subcarriers 304. The subcarriers 304 of this example represent 20 physical resource blocks (PRBs). Alternatively, the SSB 300 may be representative of a different number of subcarriers and/or PRBs.

PSS and SSS sequences are each mapped into N_{PSS}=N_{SSS}=127 consecutive subcarriers. PSS symbols occur in the first symbol of the SSB, whereas SSS symbols occur in the third symbol as explained further below.

A first one of the OFDM symbols 302 corresponds to a PSS. The PSS of this example is implemented by 127 subcarriers. Alternatively, the PSS may be implemented by a different number of subcarriers.

A second one of the OFDM symbols 302 corresponds to a PBCH. The PBCH in the second OFDM symbol is implemented by 240 subcarriers. Alternatively, the PBCH in the second OFDM symbol may be implemented by a different number of subcarriers.

A third one of the OFDM symbols 302 corresponds to a PBCH and an SSS. The SSS of this example is implemented by 127 subcarriers. Alternatively, the SSS may be implemented by a different number of subcarriers. The PBCH in the third OFDM symbol is implemented by 48 subcarriers. Alternatively, the PBCH in the third OFDM symbol may be implemented by a different number of subcarriers.

A fourth one of the OFDM symbols 302 corresponds to a PBCH. The PBCH of the fourth OFDM symbol is implemented by 240 subcarriers. Alternatively, the PBCH of the fourth OFDM symbol may be implemented by a different number of subcarriers.

### A. Acquisition Stage

Turning back to FIG. 2, the first stage 206 may be partitioned into the following operations: 1) Time and coarse frequency synchronization with PSS; 2) SSS Detection and fine frequency synchronization; 3) Time and frequency alignment to gNodeB resource grid; and 4) Cell ID Determination. For example, the wireless signal cancellation module 106 may be configured to detect and synchronize with known PSS sequences. The wireless signal cancellation module 106 may be configured to align processing in time and frequency to the 5G OFDM resource grid. The wireless signal cancellation module 106 may be configured to determine the gNodeB Cell ID.

1) Time and Coarse Frequency Synchronization with PSS

To implement the time and coarse frequency synchronization with PSS operation, the wireless signal cancellation module 106 may leverage the PSS to acquire timing and coarse frequency information on the 5G downlink. There are 3 possible m-sequences for the PSS associated respectively with three possible values of the gNodeB's cell ID sector

$${N}_{ID}^{( 2 )} ,$$

which is assumed unknown at the time of synchronization. The wireless signal cancellation module 106 forms a synchronization detection statistic for the time-domain waveform associated with each of the three sequences, and at candidate sample lags and frequency offsets at which the PSS may arrive. To allow precision in time synchronization, the wireless signal cancellation module 106 oversamples the waveform by a factor of ρ=4. Alternatively, the wireless signal cancellation module 106 may oversample by the waveform by a different factor (e.g., ρ=2, ρ=3, ρ=5, etc.). In some embodiments, this statistic is based on a Minimum Mean Squared Error (MMSE) beamforming filter whose length-R weight vector for candidate cell sector ID

$${N}_{ID}^{( 2 )}$$

is given by:

$${w}_{τ , δ f , {N}_{ID}^{( 2 )}} = {( {Z}_{0 , τ , δ f} {Z}_{0 , τ , δ f}^{H} )}^{- 1} {Z}_{0 , τ , δ f} {\tilde{x}}_{PSS , {N}_{ID}^{( 2 )}}^{H} , \qquad Equation ( 3 )$$

where Z_{0,τ,δf} is the R-by-ρN_{PSS} input data matrix capturing a window of time-domain samples starting at lag τ and with candidate frequency shift δf, and

$${\tilde{x}}_{PSS , {N}_{ID}^{( 2 )}}$$

is the 1-by-ρN_{PSS} time-domain template for the PSS waveform associated with a given candidate

$${N}_{ID}^{( 2 )} .$$

The wireless signal cancellation module 106 applies the beamforming weights in Equation (3) above to this data matrix. The norm of this beamformed data then forms the test statistic represented by Equation (4) below:

$${ϕ}_{τ , δ f , {N}_{ID}^{( 2 )}} = {‖ {w}_{τ , δ f , {N}_{ID}^{( 2 )}}^{H} {Z}_{0 , τ , δ f} ‖}^{2} , \qquad Equation ( 4 )$$

Determining the sample lag τ* corresponding to the PSS arrival, the PSS frequency offset δf*, and cell sector ID

$${N}_{ID}^{( 2 ) *}$$

then amounts to finding the peaks of

$${ϕ}_{τ , δ f , {N}_{ID}^{( 2 )}}$$

over the grid of candidate lag and frequency offsets, as well as the three possible values for

$${N}_{ID}^{( 2 )} .$$

It can be shown under the assumption of a flat-fading channel that the beamforming weights defined in Equation (3) above maximize the Signal-to-Interference-Plus-Noise-Ratio (SINR) of the beamformed output when the window is aligned with the PSS. This in turn maximizes contrast in the value of the test statistic when the test window is aligned with the PSS versus when it is misaligned and capturing the noise-plus-interference background outside the PSS.

### 2) SSS Detection and Fine Frequency Synchronization

To implement the SSS detection and fine frequency synchronization operation, the wireless signal cancellation module 106 may perform the search in frequency at a coarse granularity of half-subcarrier steps to manage overall computation time. To maximize reconstruction accuracy, a finer frequency offset determination is performed by the wireless signal cancellation module 106. The wireless signal cancellation module 106 can obtain this fine frequency estimate by examining the phase slew over the two-symbol interval between PSS and SSS, which in turn requires detection of the transmitted PSS and SSS sequences. These sequences are parameterized by the gNodeB's cell ID parameters, namely the cell ID group

$${N}_{ID}^{( 1 )}$$

and the cell ID sector

$${N}_{ID}^{( 2 )} .$$

Section A.1) above describes the example procedure for detecting PSS and

$${N}_{ID}^{( 2 )} .$$

On the other hand, SSS can be populated with 336 possible Gold sequences, each of which is associated with a distinct cell ID group/sector pair

$$( {N}_{ID}^{( 1 )} , {N}_{ID}^{( 2 )} )$$

to which the gNodeB can be assigned. Z_{0,SSS} may be specified as the R-by-N_{PSS} received data matrix which horizontally concatenates received vectors {zₖₗ} over all subcarrier indices comprising the SSS. Like a UE in gNodeB downlink acquisition, the wireless signal cancellation module 106 may compute the cross-correlation of the R-by-127 received data matrix

$${Z}_{0 , SSS}^{g}$$

in the aligned resource grid against the true 1-by-127 candidate sequence

$${x}_{SSS}^{g}$$

associated with each hypothesis. The wireless signal cancellation module 106 selects the hypothesis producing the strongest cross-correlations as the most likely transmitted SSS sequence.

The wireless signal cancellation module 106 uses the phase offset observed between the derotated PSS and SSS symbols to refine the estimate. A derotated symbol may refer to a symbol to which modulation has been removed. Namely, denoting these derotated symbols as r_{PSS} and r_{SSS} respectively, the fine frequency estimate in units of Hz is given by the example of Equation (5) below:

$${δ}_{f}^{fine} = \frac{arg {r}_{SSS} {r}_{PSS}^{*}}{{T}_{PS}} , \qquad Equation ( 5 )$$

where arg denotes the argument of a complex number, and T_{PS} is the interval (in seconds) between PSS and SSS. Due to 2π-phase ambiguities, this estimate is only unambiguous for frequency offsets within 1/T_{syms} where T_{sym} is the full duration of an OFDM symbol including cyclic prefix. Hence, the coarse synchronization described in Section A.1) is used to reduce the offset within this unambiguous range.

3) Time and Frequency Alignment to gNodeB Resource Grid

To implement the time and frequency alignment to gNodeB resource grid operation, the wireless signal cancellation module 106 aligns itself with the gNodeB resource block grid. Once the victim receiver is synchronized with the SSB, the next step for reconstruction is alignment with the resource block grid in which PDSCH and PDCCH signals are allocated. The wireless signal cancellation module 106 achieves this alignment by extracting parameters specifying the location of the SSB relative to the resource grid boundaries. For example, the wireless signal cancellation module 106 may apply standard UE demodulation and decoding to the recovered PBCH symbols to extract the Master Information Block (MIB). Within the MIB, the parameter k_{SSB} specifies the frequency offset in units 15-kHz subcarriers between the lowest subcarrier in the SSB to the nearest common resource block boundary. With this parameter in-hand, downstream blocks can align processing on resource block boundaries. Using the same procedure by 5G UEs, the frame boundary in time is determined by identifying the relative position of the SS Block within the SS Burst (known as the SSB index), whose offset with respect to the frame boundary is deterministic and fixed. This relative position is uniquely specified by the DMRS sequence used in the PBCH.

### 4) Cell ID Determination

To implement the cell ID determination operation, the wireless signal cancellation module 106 may leverage previously-detected parameters to determine the Cell ID. For example, as the gNodeB Cell ID is a seeding parameter in the PDSCH and PDCCH DMRS reference signals required for MIMO channel estimation, the wireless signal cancellation module 106 leverages previously-detected parameters to determine the Cell ID. Namely, the gNodeB's cell ID group

$${N}_{ID}^{( 1 )}$$

and cell ID sector

$${N}_{ID}^{( 2 )} ,$$

whose detection was described earlier in this section, are combined in the following way according to the 5G standard to form the Cell ID:

$${N}_{ID}^{cell} = 3 {N}_{ID}^{( 1 )} + {N}_{ID}^{( 2 )} , \qquad Equation ( 6 )$$

### B. SSB Cancellation Stage

To implement the second stage 208, the wireless signal cancellation module 106 accomplishes the excision of the SSB in the domain of the resource grid. The second stage 208 may be partitioned into the following operations: 1) PSS and SSS Excision; and 2) PBCH Excision. For example, the wireless signal cancellation module 106 may be configured to reconstruct and cancel all detected SSB(s). The wireless signal cancellation module 106 may be configured to cancel the four components of each SSB separately. For example, the wireless signal cancellation module 106 may be configured to cancel the PSS, SSS, PBCH, and PBCH DMRS separately from the received signal.

### 1) PSS and SSS Excision

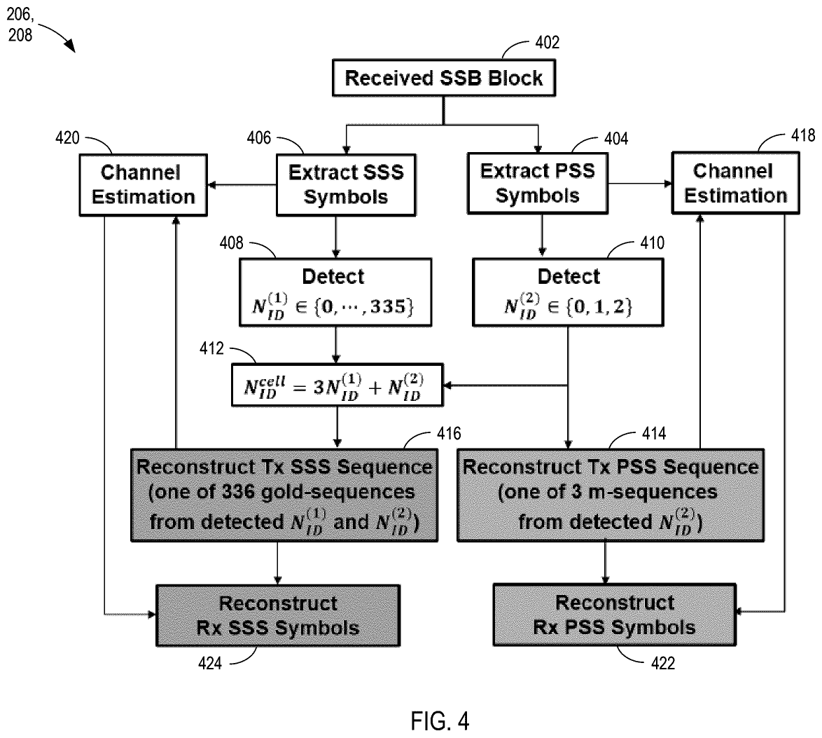

The wireless signal cancellation module 106 implements the PSS and SSS excision operation by excising the PSS and SSS reference sequences. In some embodiments, the wireless signal cancellation module 106 implements the PSS and SSS excision operation in accordance with the workflow shown in FIG. 4 for reconstructing PSS and SSS and, for completeness, the PSS and SSS detection operations describes in Section A) above. FIG. 4 is a block diagram of an example implementation of a portion of the first stage 206 and the second stage 208 of the wireless signal cancellation module 106 of FIG. 2.

In the illustrated example of FIG. 4, the wireless signal cancellation module 106 receives an SSB block to process at block 402. The wireless signal cancellation module 106 extracts PSS and SSS symbols at blocks 404, 406, respectively. The wireless signal cancellation module 106 detects the gNodeB's cell ID group

$${N}_{ID}^{( 1 )}$$

at block 408 and the cell ID sector

$${N}_{ID}^{( 2 )}$$

at block 410. The wireless signal cancellation module 106 determines the Cell ID at block 412. At block 414, the wireless signal cancellation module 106 reconstructs, using the cell ID sector

$${N}_{ID}^{( 2 )} ,$$

the transmitted PSS sequence. At block 416, the wireless signal cancellation module 106 reconstructs, using the Cell ID, the transmitted SSS sequence.

To recreate received reference signals for cancellation of a gNodeB's PSS and SSS, the wireless signal cancellation module 106 estimates the mapping from transmitted sequence to received sequence in each case at blocks 418, 420. Specifying Z_{0,PSS} analogously to Z_{0,SSS} above, as the R-by-N_{PSS} received data matrix for the PSS resource elements, the wireless signal cancellation module 106 forms estimates represented by the examples of Equation (7) and Equation (8) below:

$${\hat{m}}_{PSS} = \frac{1}{{N}_{PSS}} {Z}_{0 , PSS} {x}_{PSS}^{H} , \qquad Equation ( 7 )$$

$${\hat{m}}_{SSS} = \frac{1}{{N}_{SSS}} {Z}_{0 , SSS} {x}_{SSS}^{H} , \qquad Equation ( 8 )$$

where the g superscripts have been dropped for simplicity. These mappings are vector forms of the general R-by-L matrix mapping M specified in Equation (2) above, as PSS and SSS transmissions are single-layer (e.g., L=1). Using the estimations, the wireless signal cancellation module 106 reconstructs the received PSS and SSS symbols at blocks 422, 424.

PSS and SSS reconstructions in the resource grid are then given by \hat{Z}_{0,PSS}=\hat{m}_{PSS}x_{PSS} and \hat{Z}_{0,SSS}=\hat{m}_{SSS}x_{SSS}, respectively. The wireless signal cancellation module 106 excises PSS and SSS by subtracting these reconstructions from the received sequences in each case.

### 2) PBCH Excision

The wireless signal cancellation module 106 implements the PBCH excision operation by excising the PBCH and its DMRS. In some embodiments, the wireless signal cancellation module 106 implements the PBCH excision operation in accordance with the workflow shown in FIG. 5 for cancellation of PBCH signal components. FIG. 5 is a block diagram of an example implementation of another portion of the first stage 206 and the second stage 208 of the wireless signal cancellation module 106 of FIG. 2.

As shown in FIG. 3, PBCH symbols and their associated DMRS occupy 240, 96, and 240 subcarriers in symbol numbers 2, 3, and 4 of the SSB, respectively. As shown in FIG. 3, the PBCH DMRS symbols contain 60, 24, and 60 subcarriers in symbol numbers 2, 3, and 4 of the SSB, respectively.

The illustrated example of FIG. 5 outlines an example procedure for excising PBCH and its DMRS. First, the received PBCH

$${z}_{0 , kl}^{g}$$

and their associated DMRS are extracted from the received SSB block at blocks 502, 504, respectively. At block 506, the known DMRS reference symbols are used to estimate the single-layer mapping

$${\hat{m}}_{kl}^{g}$$

of transmitted PBCH to received PBCH, by cross-correlating received and transmitted DMRS analogously to estimation of the mapping for PSS and SSS described above. At block 508, the mapping can be undone via Minimum Mean Squared Error (MMSE) estimation to produce equalized PBCH symbols at the k-th subcarrier and l-th symbol as:

$${\hat{x}}_{kl}^{g} = {{\hat{m}}_{kl}^{gH} ( {\hat{m}}_{kl}^{g} {\hat{m}}_{kl}^{gH} + {\hat{σ}}_{n , PBCH}^{2} I )}^{- 1} {z}_{0 , kl}^{g} , \qquad Equation ( 9 )$$

where

$${\hat{σ}}_{n , PBCH}^{2}$$

is an estimate of the noise contribution to a given PBCH resource element obtained from the observed variance of PBCH DMRS reference resource elements, and I is the R-by-R Identity matrix.

As PBCH symbols are QPSK-modulated, these equalized symbols are then demodulated at block 510 with a QPSK demodulator to produce transmit symbol estimate

$${\tilde{x}}_{kl}^{g} .$$

At blocks 512, 514, 516, the received PBCH (block 516) is then reconstructed by applying the estimated mapping

$${\hat{m}}_{kl}^{g}$$

to the demodulated transmit symbols, e.g.,

$${\hat{z}}_{0 , kl}^{g} = {\hat{m}}_{kl}^{g} {\tilde{x}}_{kl}^{g} .$$

For example, the wireless signal cancellation module 106 modulates (e.g., remodulates) the demodulated transmit symbols at block 512 to reconstruct the transmitted PBCH symbols (block 514). In such an example, the wireless signal cancellation module 106 remodulates a demodulated transmit symbol by mapping the index of the demodulated transmit symbol in the QPSK constellation to its assigned value in the complex (e.g., I/Q) signaling plane. At block 516, the wireless signal cancellation module 106 reconstructs the received PBCH symbols based on the reconstructed transmitted PBCH symbols. The reconstructed received PBCH symbols at block 516 may be denoised symbols representing an estimate of a contribution of an interferer signal, such as RF waveforms 124, 126 emitted from the interferer emitters 108, 110, at the radar detection system 102, where the contribution of the interferer signal is isolated from all other sources.

At blocks 518, 520, the wireless signal cancellation module 106 reconstructs the RX PBCH DMRS symbols. RX PBCH DMRS symbol reconstruction. PBCH DMRS reconstruction leverages the same estimated mapping,

$${\hat{m}}_{kl}^{g} ,$$

but applies it instead to map the known transmitted DMRS reference pattern in the resource grid in each PBCH to the receiver. This pattern is deterministically parameterized by the SSB index of its host SSB (i_{SSB}) in the SS Burst as well as the gNodeB's cell ID

$${N}_{ID}^{cell} .$$

Returning to FIG. 2, once PBCH and associated DMRS symbols are reconstructed in the resource grid, they are simply subtracted from the received signal at the corresponding resource elements to complete the excision. The resulting SSB-excised signal z is then passed to the downstream blocks for detection and cancellation of PDSCH and PDCCH.

### C. Detection of Allocations

The third stage 210 may be partitioned into the following operations: 1) Coarse and Fine Detection Maps; 2) DMRS Parameter Detection; and 3) PDSCH/PDCCH Partitioning. For example, the wireless signal cancellation module 106 may be configured to implement a coarse detection stage (e.g., a coarse allocation detection stage) in which the wireless signal cancellation module 106 detects occupied OFDM RBs using Spectral Differencing. The wireless signal cancellation module 106 may be configured to implement a fine detection stage (e.g., a fine allocation detection stage) in which the wireless signal cancellation module 106 detects PDSCH DMRS configuration and active antenna ports. Further in the fine stage, the wireless signal cancellation module 106 may be configured to extract gNodeB- and port-specific allocations.

### 1) Coarse and Fine Detection Maps

In some embodiments, the wireless signal cancellation module 106 implements the coarse and fine detection maps operation by using Spectral Differencing. In some such embodiments and other embodiments described herein, the wireless signal cancellation module 106 may perform Spectral Differencing using example techniques described by K. W. Forsythe, “Utilizing waveform features for adaptive beamforming and direction finding with narrowband signals,” Lincoln Laboratory Journal, vol. 10, no. 2, 1997, which is incorporated by reference in its entirety.

The demodulation/remodulation and excision operations described below in Section D take identification of all the occupied OFDM resource blocks (RBs) associated with each gNodeB as input. The wireless signal cancellation module 106 achieves detection of these RBs in several operations using Spectral Differencing. The first operation involves use of Spectral Differencing with an unknown array response to detect all allocations in the observation bandwidth. These detections, which represent the union of all gNodeB allocations, are used in a subsequent operation to obtain DMRS-derived array responses for each gNodeB antenna port. Finally, leveraging the DMRS-derived port array responses, Spectral Differencing with a known array response is used to identify the gNodeB g-specific allocations in each resource grid. This operation takes prior identification of the DMRS configuration as input; this identification algorithm and/or technique is provided in Section C.2) below. The entire process of using unknown Spectral Differencing to obtain a set of “coarse” detections, followed by using known Spectral Differencing to obtain “fine” (or refined) detections, is performed using the resource grids z^{g}, for each gNodeB g, after completing the SSB excision described above in Section B.

Both stages of Spectral Differencing proceed by considering various nearby training and testing regions of the resource grid and making a decision based on a detection statistic. For each training and testing region, Λₜᵣₐᵢₙ and Λₜₑₛₜ, specified by a subset of subcarrier and symbol indices into the resource grid, a generalized likelihood ratio test (GLRT) statistic is formed. Specifically, for the case of Spectral Differencing with an unknown array response, the GLRT statistic is approximately given by the example of Equation (10) below:

$${d}_{GLRT} ( {I}_{train} , {I}_{test} ) = \frac{1}{R} Tr [ {ℛ ( {I}_{train} )}^{- 1} ℛ ( {I}_{test} ) ] , \qquad Equation ( 10 )$$

where [symbol] (I) is the R×R spatial covariance estimated over the region I. For the case of Spectral Differencing with a known array response, the GLRT statistic is given by the example of Equation (11) below:

$${d}_{GLRT} ( {I}_{train} , {I}_{test} ) = \frac{{\hat{m}}_{p}^{H} {ℛ ( {I}_{train} )}^{- 1} {\hat{m}}_{p}}{{\hat{m}}_{p}^{H} {ℛ ( {I}_{train} ⋃ {I}_{test} )}^{- 1} {\hat{m}}_{p}} , \qquad Equation ( 11 )$$

where \hat{m}ₚ represents an estimate of the R×1 port array response for port p. Specifically, the wireless signal cancellation module 106 obtains an estimate \hat{m}ₚ by cross-correlating the received R×N_{DMRS} DMRS data matrix Z_{DMRS,p} associated with port p with its 1×N_{DMRS} template x_{DMRS,p} over the detected resource blocks in the coarse detection map, i.e.,

$${\hat{m}}_{p} = \frac{1}{{N}_{DMRS}} {Z}_{DMRS , p} {x}_{DMRS , p}^{H} , \qquad Equation ( 12 )$$

In some embodiments, the wireless signal cancellation module 106 obtains the received R×N_{DMRS} DMRS data matrix by horizontally concatenating column vectors {zₖₗ} belonging to the set of resource elements, i.e., (k, l), pairs allocated to DMRS.

In some embodiments, for both Spectral Differencing with an unknown and known array response, the wireless signal cancellation module 106 produces detection maps by considering temporally adjacent training and testing regions of the resource grid, where each region extends one resource block (RB) or 12 subcarriers in frequency and two symbols in time. The wireless signal cancellation module 106 sweeps the configuration forward and backward (temporally) across the resource grid (training region always trailing the testing region) for each RB. The wireless signal cancellation module 106 computes the detection statistic at each position and associated with the interface of the two regions. Peaks in the detection statistic exceeding some pre-specified threshold θ>1 on the forward pass indicate the starting symbol of a detection region; likewise peaks that exceed the threshold on the backward pass indicate the ending symbols of the detection region. Such peaks typically occur when the location of the interface between training and testing regions coincide with OFDM allocation boundaries. The wireless signal cancellation module 106 produces a boolean detection map by classifying regions of the resource grid that span adjacent pairs of forward and backward sweep detection points as allocations.

In some embodiments, the wireless signal cancellation module 106 performs Spectral Differencing on a per resource block (RB) basis using a 15 kHz subcarrier spacing (SCS) resource grid, noting that a RB represents the smallest resource unit that can be allocated to a user. In some embodiments, while allocations need not necessarily be associated with a 15 kHz bandwidth part (BWP), this choice of grid may ensure that regardless of the true SCS of the allocation, a detection map with a sufficient resolution in the frequency domain is produced (albeit while sacrificing resolution in the time domain). In some embodiments, the wireless signal cancellation module 106 determines the subcarrier grouping associated with each RB with knowledge of k_{SSB} extracted from the detection and synchronization block described in Section A above.

In some embodiments, the wireless signal cancellation module 106 estimates the threshold, θ, from Monte Carlo (MC) simulations for a given number of receive antennas, R, cardinality of training and test regions, |Iₜᵣₐᵢₙ| and |Iₜₑₛₜ|, and a desired probability of false alarm occurrence (PFA) within the full Spectral Differencing output spanning the time/frequency signal domain. Specifically, the probability of false alarm per trial (PFAₜ) as a function of threshold can be estimated from the empirical cumulative distribution function for d_{GLRT}(Iₜᵣₐᵢₙ, Iₜₑₛₜ) with training and test regions comprising uncorrelated noise (note that, in some embodiments, for Spectral Differencing with a known array response, the empirical distribution function is independent of the magnitude and orientation of the array response). Trial may refer to a fixed position of the Spectral Differencing filter.

For a single-frame 15 kHz resource grid with 4096 subcarriers, the AEP output comprises Nₜᵣᵢₐₗₛ˜10⁵ correlated estimates of d_{GLRT}, noting that training and testing windows associated with adjacent AEP outputs overlap in the time domain but not in frequency domain. For uncorrelated trials, the probability of false alarm per trial is given by PFAₜ=1−(1−PFA)^{1/N}^{ₜ}; the presence of correlations means the effective number of trials is less than Nₜ and therefore the threshold needed to attain a given PFA using this relation will be overestimated (i.e., the true PFA will be smaller than the targeted value for a given threshold). Combining knowledge of the relationship between PFA and PFAₜ, and the relationship between PFAₜ and θ enables one to determine θ as a function of the desired PFA. As an example with R=2 and |Iₜᵣₐᵢₙ|=|Iₜₑₛₜ|=24 and a target PFA˜0.5 (i.e., a 50% probability that single false detection occurs in all the Spectral Differencing sweeps), one finds from MC simulation θ˜2.5 (unknown Spectral Differencing) and θ˜3 (known Spectral Differencing). By way of example, a conservative threshold value of θ=4 may be used, which is expected to yield a PFA<0.5 for the entire resource grid.

### 2) DMRS Parameter Detection

The DMRS of any given PDSCH allocation is highly configurable, and most of the configuration parameters are communicated through Radio Resource Control (RRC) messages mapped to separate PDSCH allocations scheduled beforehand. These parameters are the lag r of the frequency reference at which the sequence is anchored in the resource grid, the number, SCS, the scrambling ID N_{SCID} and layout pattern of the DMRS symbols in each resource block (which can be consolidated into a single DMRS pattern hypothesis), and the indices of the active antenna ports over which DMRS is transmitted. In some embodiments, the frequency reference at which the sequence is anchored in the resource grid may be either subcarrier 0 of either the lowest-numbered common resource block in PBCH-configured CORESET in the case of SIB1-carrying PDSCH, or common resource block 0 (CRB0) otherwise. In some embodiments, the DMRS sequences are also parameterized by N_{ID}^{cell} obtained in the first stage 206.

In some embodiments, reliable capture of these RRC messages may not be assumed in the constrained scheduling and bandwidth constraints of the victim receiver. Instead, the approach described herein is directed to the detection of the DMRS parameters through the framework of maximum likelihood sequence detection. For example, assume that the background in the measurement model (i.e.,

$${b}_{kl}^{g} + {n}_{kl}^{g} )$$

in Equation (2) above is i.i.d. Gaussian-distributed across DMRS resource elements. The log likelihood function for the c^{t}^{^{h}} DMRS signal pattern hypothesis, lag hypothesis τ, and p^{t}^{^{h}} DMRS antenna port can then be computed by the wireless signal cancellation module 106 over the set I_{DMRS} of DMRS resource elements as:

$$log p ( \{ {z}_{kl}^{g} \} \vert \{ {d}_{kl}^{cp τ} \} ) = C - \frac{1}{2} {\sum }_{k , l ∈ {I}_{DMRS}} {( {z}_{kl}^{g} - {d}_{kl}^{cp τ} {m}_{kl}^{cp τ} )}^{H} {\sum }^{- 1} ( {z}_{kl}^{g} - {d}_{kl}^{cp τ} {m}_{kl}^{cp τ} ) , \qquad Equation ( 13 )$$

where

$$\{ {d}_{kl}^{cp τ} \}$$

is the set of symbols comprising the DMRS template associated with this hypothesis,

$${m}_{kl}^{cp τ}$$

is the resulting layer-to-receive-channel mapping vector estimate conditioned on this hypothesis, Σ is the estimated spatial covariance matrix of background, and C is a constant whose value is independent of the DMRS parameters. Under the assumption of a spatially-white background with noise power

$${σ}_{n}^{2} ,$$

and omitting all terms that are independent of the unknown parameters we wish to detect, the wireless signal cancellation module 106 obtains the following log likelihood score:

$${ℒ}_{s} ( \{ {z}_{kl}^{g} \} \vert \{ {d}_{kl}^{cp τ} \} ) = \frac{1}{{σ}_{n}^{2}} {\sum }_{k , l ∈ {I}_{DMRS}} ℜ ( {z}_{kl}^{gH} {m}_{kl}^{cp τ} {d}_{kl}^{cp τ} ) - \frac{1}{2} {( {m}_{kl}^{cp τ} {d}_{kl}^{cp τ} )}^{H} ( {m}_{kl}^{cp τ} {d}_{kl}^{cp τ} ) , \qquad Equation ( 14 )$$

The wireless signal cancellation module 106 then sums this score over the Nₚ possible antenna ports to obtain an aggregate score for c-th parameter hypothesis at candidate lag τ:

$${ℒ}_{agg} ( \{ {z}_{kl}^{g} \} \vert \{ {d}_{kl}^{cp τ} \} ) = {\sum }_{p = 1}^{{N}_{p}} {ℒ}_{s} ( {z}_{kl}^{g} \vert {d}_{kl}^{cp τ} ) , \qquad Equation ( 15 )$$

The inferred DMRS parameters (c*, τ*) are those that maximize this aggregate score. The wireless signal cancellation module 106 identifies a given antenna port p active if its corresponding likelihood score under the inferred DMRS hypothesis and lag, i.e.,

$${ℒ}_{s} ( \{ {z}_{kl}^{g} \} \vert \{ {d}_{kl}^{c * p τ *} \} )$$

exceeds a threshold. The threshold may be predetermined. For example, threshold may be a user- and/or system-specified threshold.

### 3) PDSCH/PDCCH Partitioning

The wireless signal cancellation module 106 implements the PDSCH/PDCCH partitioning operation by assigning detected resource blocks as either PDSCH or PDCCH, as reconstruction proceeds differently in each case. The wireless signal cancellation module 106 may exploit the fact that the PDCCH DMRS sequence is distinct from the full set of possible PDSCH DMRS sequences. For example, PDCCH features a single DMRS symbol placed at every 4-th subcarrier in the resource grid, which is not a valid configuration of PDSCH DMRS. Accordingly, the wireless signal cancellation module 106 can compare the power in the output of a matched filter constructed with the distinct PDCCH DMRS template against a threshold (e.g., a predetermined threshold), in order to unambiguously identify the presence of PDCCH.

### D. PDSCH/PDCCH Cancellation

The fourth stage 212 may be partitioned into the following operations: 1) Channel Equalization; 2) Modulation Classification; and 3) Demodulation/Remodulation. For example, the wireless signal cancellation module 106 may be configured, for each detected gNodeB: (i) use gNodeB-specific DMRS to partition allocations between PDSCH and PDCCH and (ii) demodulate, reconstruct, and cancel PDSCH/PDCCH using DMRS reference signals for channel estimation.

### 1) Channel Equalization

The wireless signal cancellation module 106 can perform channel estimation and equalization when the DMRS parameters and antenna ports are known. The wireless signal cancellation module 106 may perform channel estimation and equalization on a layer-by-layer basis to arrive at the channel estimate

$${\hat{M}}_{kl}^{g}$$

and the symbol estimate

$${\hat{x}}_{kl}^{g} .$$

While the DMRS reference signal components (known as “resource elements”) providing direct channel estimates are placed sparsely within the OFDM resource grid, interpolation may be used to obtain channel estimates at locations in the grid where DMRS is not present. The wireless signal cancellation module 106 may use and/or otherwise implement an MMSE channel equalizer, which may take the general form of:

$${\hat{x}}_{kl}^{g} - {{\hat{M}}_{kl}^{gH} ( {\hat{M}}_{kl}^{g} {\hat{M}}_{kl}^{gH} + {\hat{R}}_{kl}^{ni} )}^{- 1} {z}_{kl}^{g} , \qquad Equation ( 16 )$$

where

$${\hat{R}}_{kl}^{ni}$$

is the noise plus interference covariance matrix.

$${\hat{R}}_{kl}^{ni}$$

can be decomposed into interference and (spatially white) noise contributions as shown below in the example of Equation (17):

$${\hat{R}}_{kl}^{ni} = {\hat{R}}_{kl}^{i} + {\hat{σ}}_{n}^{2} I , \qquad Equation ( 17 )$$

where

$${\hat{R}}_{kl}^{i}$$

is summed by combining the rank-1 covariance matrices formed from the port array responses for interfering gNodeB ports (see Section C.2) above), and noise variance

$${\hat{σ}}_{n}^{2}$$

is estimated using the variance of DMRS.

### 2) Modulation Classification

In some embodiments, the wireless signal cancellation module 106 performs modulation classification. Whereas the modulation of PBCH and PDCCH is fixed (to Quadrature Phase Shift Keying (QPSK)), PDSCH resource elements may be modulated in one of four possible modulation types: QPSK, 16QAM (Quadrature Modulation), 64QAM, and 256QAM. In some embodiments, the wireless signal cancellation module 106 executes and/or instantiates a Gaussian Mixture Model (GMM) to classify the modulation via Maximum Likelihood Estimation (MLE). Namely, for uncorrelated symbols, the maximum likelihood estimator for the modulation can be given by the example of Equation (18) below:

$${\hat{m}}^{g} ( {I}_{PDSCH} ) = arg max {\sum }_{k , l ∈ {I}_{PDSCH}} {\sum }_{q = 1}^{L} log {ℒ}_{m} ( {\hat{x}}_{klq}^{g} , \vert {\hat{μ}}_{q}^{g} \vert , {\hat{σ}}_{n , eq} ) , \qquad Equation ( 18 )$$

where

$${\hat{x}}_{klq}^{g}$$

∈C represents the q-th component of the equalized PDSCH symbols

$${\hat{x}}_{kl}^{g}$$

(q=1, . . . , L),

$${\vert {\hat{μ}}_{q}^{g} \vert}^{2} = \frac{1}{\vert {I}_{PDSCH} \vert} {\sum }_{k , l ∈ {I}_{PDSCH}} {\vert {\hat{x}}_{klq}^{g} \vert}^{2} - {\hat{σ}}_{n , eq}^{2} , \qquad Equation ( 19 )$$

represents the signal power associated with the q-th component of the symbols, and

$${\hat{σ}}_{n , eq}^{2}$$

represents the post-equalization DMRS noise variance computed in Section D.1), respectively. The univariate probability distribution function for the constellation symbols can be taken to be:

$${ℒ}_{m} ( z , \vert μ \vert , σ ) = {\sum }_{i = 1}^{{N}_{m}} 𝒩 ( z , \vert μ \vert {e}_{i}^{m} , σ ) , \qquad Equation ( 20 )$$

where

$${e}_{i}^{m}$$

∈C represent the normalized symbol locations for the constellation of modulation m, which satisfy

$${\sum }_{i = 1}^{{N}_{m}} {\vert {e}_{i}^{m} \vert}^{2} = {N}_{m} ,$$

Nₘ represents the total number of symbols in the constellation, and [symbol] (z, μ, σ) represents a complex normal distribution function with mean μ and variance σ².

### 3) Demodulation/Remodulation

In some embodiments, the wireless signal cancellation module 106 reconstructs and subtracts the 5G signal from the received signal. The reconstructed signal is formed by applying the channel estimate to the demodulated symbols:

$${\hat{z}}_{k l}^{g} = {\hat{M}}_{k l}^{g} {\hat{x}}_{k l}^{g} , \qquad Equation ( 21 )$$

Ideally, the wireless signal cancellation module 106 may be configured to completely eliminate this gNodeB signal from the received signal in Equation (2) above to be left with any remaining interference plus noise,

$${b}_{k l}^{g} + {n}_{k l}^{g} .$$

In some embodiments, the wireless signal cancellation module 106 generates the residual as the residual wireless signals 134. For example, the wireless signal cancellation module 106 may generate the residual wireless signals 134 as the difference between the received signal and the reconstructed signal,

$${z}_{k l}^{g} - {\hat{z}}_{k l}^{g} .$$

FIG. 6 shows an example simulation scenario 600. The simulation scenario 600 shown is a radar scenario in which a radar detection system 602 is tracking a target 604. A wireless receiver (e.g., a radar receiver) of the radar detection system 602 in the simulation scenario 600 is receiving interfering signals from 5G base stations 606, 608. For example, the radar detection system 602 may be implemented by and/or correspond to the radar detection system 102 of FIG. 1. The target 604 may be implemented by and/or correspond to the target 104 of FIG. 1. A first 5G base station 606 (identified by 5G Base Station 1) may be implemented by and/or correspond to the first interferer emitter 108 of FIG. 1. A second 5G base station 608 (identified by 5G Base Station 2) may be implemented by and/or correspond to the second interferer emitter 110 of FIG. 1.

In the illustrated example of FIG. 6, the radar detection system 602 observes interference from two co-channel 5G base stations 606, 608 that dominates the signal-of-interest reflected by the target 604. This 5G interference includes several 5G waveform elements depicted in a first spectrogram 610 and a second spectrogram 612. The 5G waveform elements 614, 616, 618 include the SSB 614 used by UE (e.g., handsets) for acquisition, as well as user data allocations PDSCH 616 and control data allocations PDCCH 618.

A third spectrogram 620 shows a target signal component 622. The target signal component of this example is a linear frequency modulated (LFM) chirp with 5 Megahertz (MHz) bandwidth.

In the shown example, the 5G waveform elements 614, 616, 618 and the target signal component 622 combine at the radar receiver of the radar detection system 602. The combination of the signal components is shown in a fourth spectrogram 624.

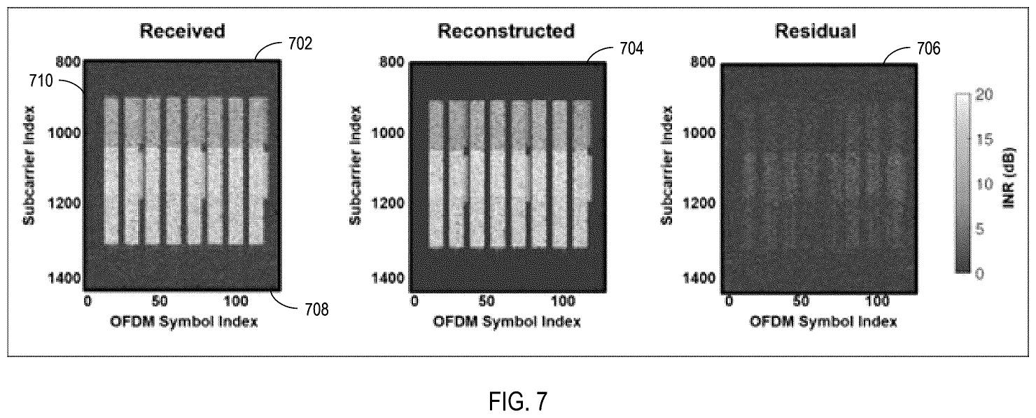

FIG. 7 shows plots 702, 704, 706 for example received, reconstructed, and residual wireless signals. The horizontal axis 708 of the plots 702, 704, 706 is the OFDM symbol index. The vertical axis 710 of the plots 702, 704, 706 is the subcarrier index.

The plots 702, 704, 706 include a first plot 702, which represents emulated interference from multiple wireless signals with overlapping allocations in time/frequency. For example, the first plot 702 may represent digitized RF signals received on the antennas 112 of FIG. 1. In such an example, the first plot 702 may represent digitized RF signals from one of the sub-arrays 116, 118, 120 of FIG. 1.

A second plot 704 is shown and represents reconstructed digitized RF signals. For example, the second plot 704 may represent denoised symbols reconstructed by the wireless signal cancellation module 106. The reconstructed denoised symbols illustrated in the second plot 704 may represent an estimate of a contribution of an interferer signal at a wireless receiver, such as the antennas 112 of the radar detection system 102 of FIG. 1. In such an example, the contribution of the interferer signal may be isolated from all other sources.

A third plot 706 is shown and represents a residual wireless signal. For example, the third plot 706 may represent the residual wireless signals 134 of FIG. 1. By way of example, the wireless signal cancellation module 106 may detect the physical layer state of each base station's waveform (e.g., the waveforms of the interferer emitters 108, 110 of FIG. 1) and isolate its contribution to the received signal multiplex. Furthering the example, the wireless signal cancellation module 106 may then cancel each reconstructed component individually, leaving an interference residual with significantly reduced interference-to-noise ratio (INR) (measured in decibels (dB) as shown in the third plot 706.

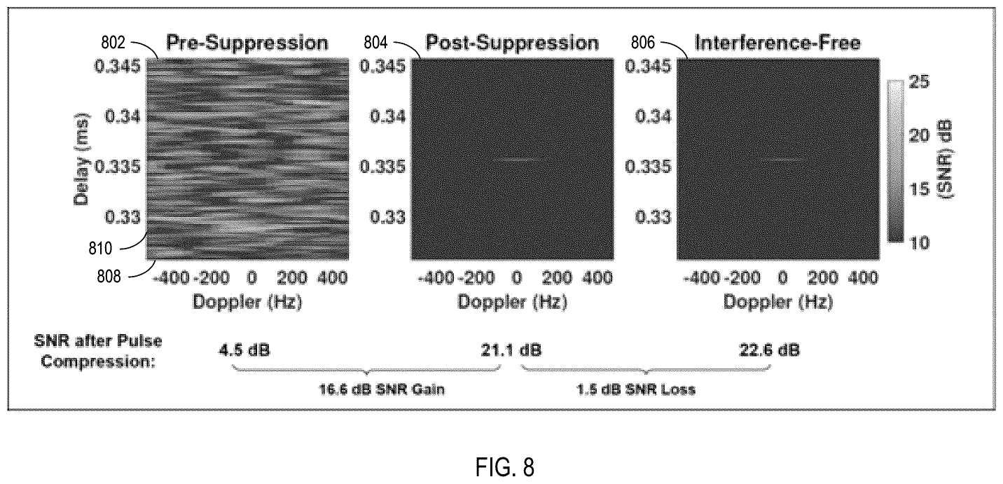

FIG. 8 shows plots 802, 804, 806 for pre-suppression, post-suppression, and interference-free wireless signals, respectively. As shown, a horizontal axis 808 of the plots 802, 804, 806 is a Doppler frequency measured in Hertz (Hz). A vertical axis 810 of the plots 802, 804, 806 is a delay measured in milliseconds (ms).

The plots 802, 804, 806 correspond to an example in which the wireless receiver is a radar receiver. For example, the plots 802, 804, 806 may correspond to the example of FIG. 1. Typical radars apply matched filtering to the signal-of-interest to localize a target in delay and Doppler, or equivalently range and velocity respectively. The second plot 804 shows the output of this pulse compression process for the example radar scenario. If this pulse compression processing is applied directly to the signal multiplex, there is no clearly detectable peak as the target signal is buried in the clutter of 5G interference (as shown in the first plot 802). On the other hand, if the 5G interference is first canceled using the reconstruction templates depicted in the second plot 704 of FIG. 7, the peak associated with the target is restored as shown in the second plot 804 of FIG. 8. The loss in SNR relative to the interference-free case (shown in the third plot 806 of FIG. 8) is 1.5 dB, which would limit reduction in detection range to 92% in this example.

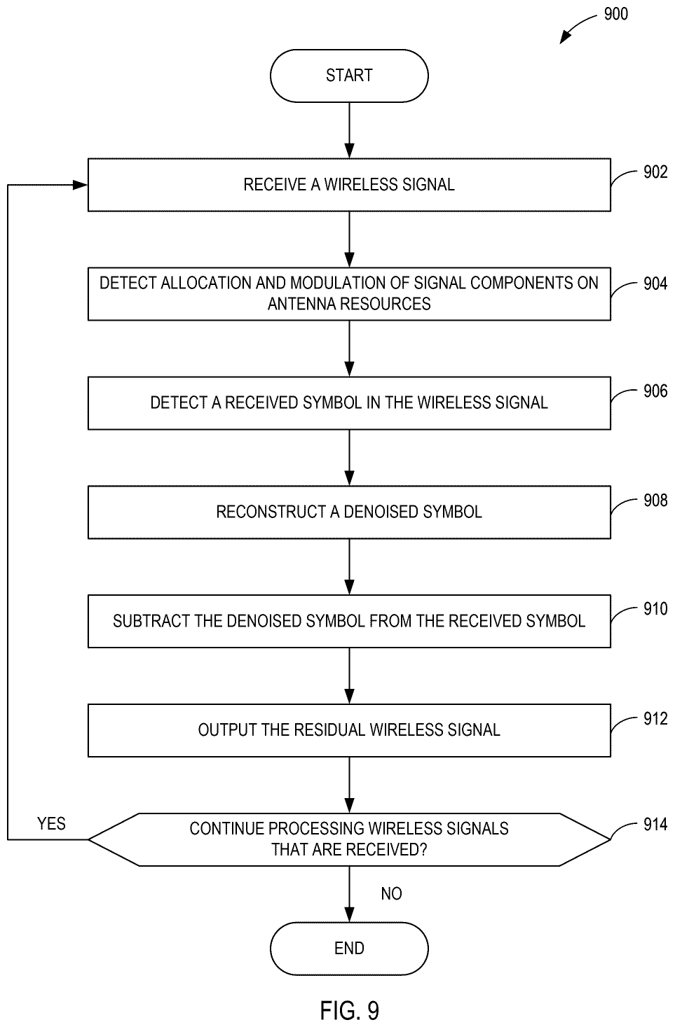

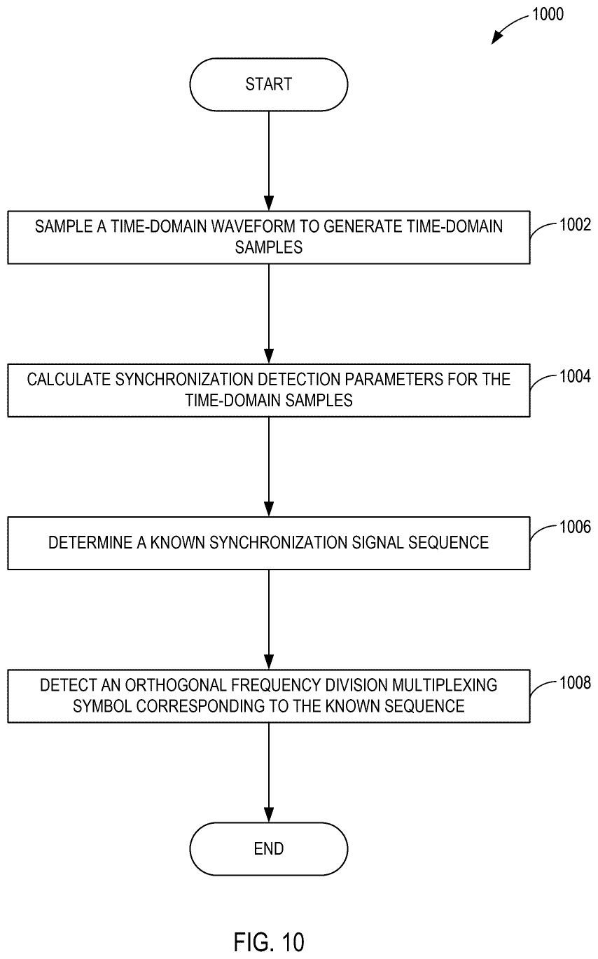

FIGS. 9 and 10 are flowcharts representative of example processes to be performed to implement the wireless signal cancellation module 106. In some embodiments, FIGS. 9 and/or 10 may be representative of example machine-readable instructions that may be executed by processor circuitry to implement the wireless signal cancellation module 106. Additionally or alternatively, block(s) of one(s) of the flowcharts of FIGS. 9 and/or 10 may be representative of state(s) of one or more hardware-implemented state machines, algorithm(s) that may be implemented by hardware alone such as an ASIC, etc., and/or any combination(s) thereof.

FIG. 9 is a flowchart 900 representative of an example process that may be performed and/or example machine-readable instructions that may be executed by processor circuitry to implement the wireless signal cancellation module 106 of FIGS. 1 and/or 2 to reduce signal interference from an interferer emitter. The flowchart 900 of FIG. 9 begins at block 902, at which the wireless signal cancellation module 106 of FIGS. 1 and/or 2 may receive wireless signal. For example, the radar detection system 102 may receive the RF waveforms 122, 124, 126 of FIG. 1 on one or more of the antennas 112. The sub-arrays 116, 118, 120 may convert the RF waveforms 122, 124, 126 into the digitized RF signals 132. The wireless signal cancellation module 106 may receive the wireless signal, such as a digitized version of the wireless signal received on the antennas 112 from the sub-arrays 116, 118, 120.

At block 904, the wireless signal cancellation module 106 may detect allocation and modulation of signal components on temporal, spectral, and/or spatial (e.g., antenna) resources. By way of example, the wireless signal cancellation module 106 may detect, using Spectral Differencing processing, occupied OFDM RBs during a coarse detection stage. The wireless signal cancellation module 106 may detect PDSCH DMRS configuration and active antenna ports during a fine detection stage. Further in the fine detection stage, the wireless signal cancellation module 106 may extract gNodeB- and port-specific allocations. In some embodiments, the wireless signal cancellation module 106 may classify PDSCH resource elements as being modulated in one of four possible modulation types: QPSK, 16QAM, 64QAM, and 256QAM. In such an example, the wireless signal cancellation module 106 may execute and/or instantiate a GMM to classify the modulation via MLE as described above.

At block 906, the wireless signal cancellation module 106 may detect a received symbol in the wireless signal. For example, when the DMRS parameters antenna ports are known, the wireless signal cancellation module 106 may perform channel estimation and equalization. The wireless signal cancellation module 106 may perform these operations on a layer-by-layer basis to arrive at the channel estimate

$${\hat{M}}_{k l}^{g}$$

and the symbol estimate

$${\hat{x}}_{k l}^{g} .$$

The wireless signal cancellation module 106 may detect a received symbol in the wireless symbol by identifying one or more received symbols in the symbol estimate

$${\hat{x}}_{k l}^{g} .$$

An example process that may implement block 906 is described in connection with FIG. 10.

At block 908, the wireless signal cancellation module 106 may reconstruct a denoised symbol. For example, the wireless signal cancellation module 106 may form the reconstructed signal

$${\hat{z}}_{k l}^{g}$$

by applying the channel estimate to the demodulated symbols using the example of Equation (21) above. The reconstructed signal

$${\hat{z}}_{k l}^{g}$$

may include one or more denoised symbols.

At block 910, the wireless signal cancellation module 106 may subtract the denoised symbol from the received symbol. For example, the wireless signal cancellation module 106 may subtract the reconstructed signal from the received signal, which is represented by the example of Equation (2) above, to be left with any remaining interference plus noise. In such an example, a residual wireless signal results from the subtraction of the reconstructed signal from the received signal.

At block 912, the wireless signal cancellation module 106 may output the residual wireless signal. For example, the wireless signal cancellation module 106 may generate the residual wireless signal 134 by subtracting the reconstructed signal from the received signal. In such an example, the wireless signal cancellation module 106 may output the residual wireless signal 134 to the adaptive beamforming module 136 for further processing. Furthering the example, the radar detection system 102 may execute, using the residual wireless signal 134, one or more detection and tracking operations of the target 104.

At block 914, the wireless signal cancellation module 106 may determine whether to continue processing wireless signals that are received. For example, the wireless signal cancellation module 106 may determine that further RF signals are received on the antennas 112 for processing by the wireless signal cancellation module 106.

If, at block 914, the wireless signal cancellation module 106 determines to continue processing wireless signals that are received, control returns to block 902. Otherwise, the flowchart 900 of FIG. 9 concludes.

FIG. 10 is a flowchart 1000 representative of an example process that may be performed and/or example machine-readable instructions that may be executed by processor circuitry to implement the wireless signal cancellation module 106 of FIGS. 1 and/or 2 to detect a received symbol. In some embodiments, the flowchart 1000 of FIG. 10 may implement block 906 of the flowchart 900 of FIG. 9.

The flowchart 1000 of FIG. 10 begins at block 1002, at which the wireless signal cancellation module 106 samples a time-domain waveform to generate time-domain samples. For example, the wireless signal cancellation module 106 may leverage the PSS to acquire timing and coarse frequency information on the 5G downlink. In such an example, the wireless signal cancellation module 106 may sample the PSS waveform to capture a window of time-domain samples for the PSS waveform starting at lag τ and with candidate frequency shift δf as described above in Section A.1).

At block 1004, the wireless signal cancellation module 106 may calculate synchronization detection parameters for the time-domain samples. The synchronization detection parameters may be the synchronization detection statistics formed for the time-domain waveform associated with each of the three possible m-sequences for the PSS associated respectively with three possible values of the gNodeB's cell ID sector

$${N}_{ID}^{( 2 )} .$$

For example, the wireless signal cancellation module 106 may calculate the synchronization detection statistics using the example of Equation (4) above.

At block 1006, the wireless signal cancellation module 106 may determine a known synchronization signal sequence. For example, the wireless signal cancellation module 106 may determine a known PSS sequence by identifying the peaks of

$${ϕ}_{τ , δ f , {N}_{D}^{( 2 )}}$$

over the grid of candidate lag and frequency offsets as described above in Section A.1). In some embodiments, the wireless signal cancellation module 106 may determine a known SSS sequence by computing the cross-correlation of the R-by-127 received data matrix

$${Z}_{0 , SSS}^{g}$$

in the aligned resource grid against the true 1-by-127 candidate sequence

$${x}_{S S S}^{g}$$

associated with each hypothesis as described above in Section A.2). The wireless signal cancellation module 106 selects the hypothesis producing the strongest cross-correlations as the most likely transmitted SSS sequence.

At block 1008, the wireless signal cancellation module 106 may detect an orthogonal frequency division multiplexing symbol corresponding to the known sequence. For example, once the victim receiver (e.g., the radar receiver of the radar detection system 102) is synchronized with the SSB, the wireless signal cancellation module 106 may align itself with the resource block grid in which PDSCH and PDCCH signals are allocated as described above in Section A.2). In such an example, the wireless signal cancellation module 106 may detect, in accordance with the determined and known PSS and/or SSS sequences, PBCH symbols in the resource block grid.

After detecting an orthogonal frequency division multiplexing symbol corresponding to the known sequence at block 1008, the flowchart 1000 of FIG. 10 concludes. For example, the flowchart 1000 of FIG. 10 may return to block 908 of FIG. 9 to reconstruct a denoised symbol.

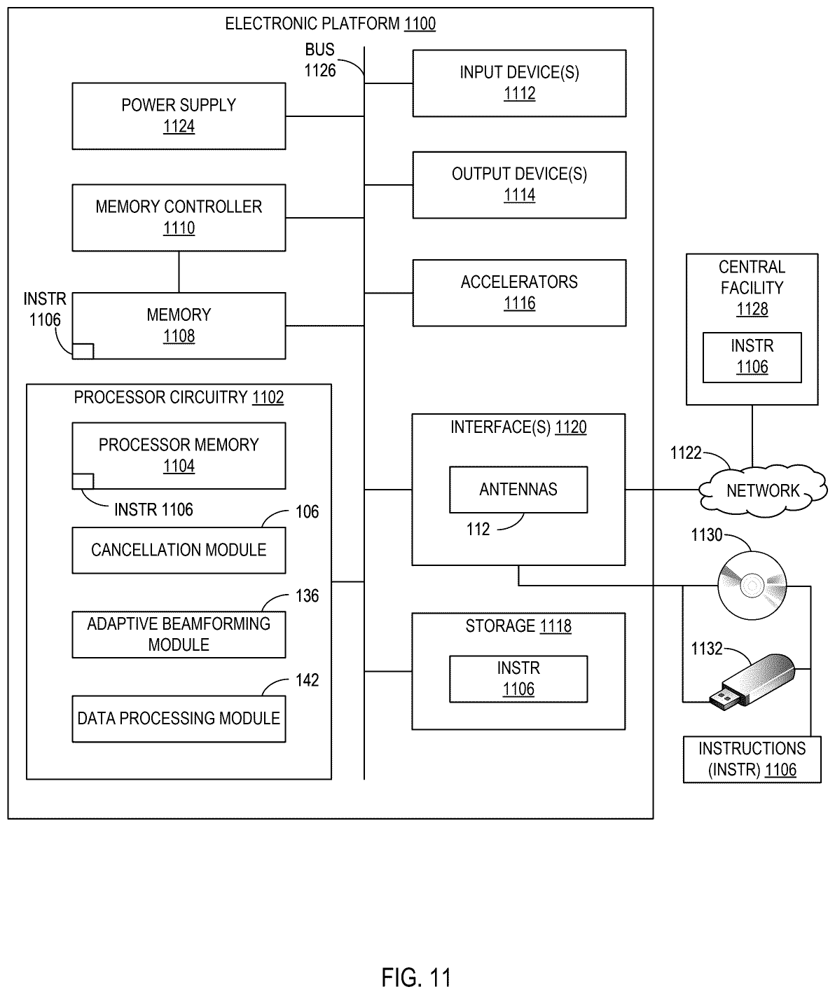

FIG. 11 is an example implementation of an electronic platform 1100 structured to execute the machine-readable instructions of FIGS. 9 and/or 10 to implement the wireless signal cancellation module 106 and/or, more generally, the radar detection system 102 of FIG. 1. It should be appreciated that FIG. 11 is intended neither to be a description of necessary components for an electronic and/or computing device to operate as a radar detection system, in accordance with the techniques described herein, nor a comprehensive depiction. The electronic platform 1100 of this example may be a radar detection system. Alternatively, the electronic platform 1100 may be an electronic device, such as a handset device (e.g., a cellular network device, a smartphone, etc.), a desktop computer, a laptop computer, a tablet computer, a server (e.g., a computer server, a blade server, a rack-mounted server, etc.), a workstation, or any other type of computing and/or electronic device.

The electronic platform 1100 of the illustrated example includes processor circuitry 1102, which may be implemented by one or more programmable processors, one or more hardware-implemented state machines, one or more ASICs, etc., and/or any combination(s) thereof. For example, the one or more programmable processors may include one or more CPUs, one or more DSPs, one or more FPGAs, one or more GPUs, etc., and/or any combination(s) thereof. The processor circuitry 1102 includes processor memory 1104, which may be volatile memory, such as random-access memory (RAM) of any type. The processor circuitry 1102 of this example implements the wireless signal cancellation module 106 (identified by CANCELLATION MODULE), the adaptive beamforming module 136, and the data processing module 142 of FIG. 1.

The processor circuitry 1102 may execute machine-readable instructions 1106 (identified by INSTRUCTIONS), which are stored in the processor memory 1104, to implement at least one of the wireless signal cancellation module 106, the adaptive beamforming module 136, or the data processing module 142 of FIG. 1. The machine-readable instructions 1106 may include data representative of computer-executable and/or machine-executable instructions implementing techniques that operate according to the techniques described herein. For example, the machine-readable instructions 1106 may include data (e.g., code, embedded software (e.g., firmware), software, etc.) representative of the flowcharts of FIGS. 9 and/or 10, or portion(s) thereof.

The electronic platform 1100 includes memory 1108, which may include the instructions 1106. The memory 1108 of this example may be controlled by a memory controller 1110. For example, the memory controller 1110 may control reads, writes, and/or, more generally, access(es) to the memory 1108 by other component(s) of the electronic platform 1100. The memory 1108 of this example may be implemented by volatile memory, non-volatile memory, etc., and/or any combination(s) thereof. For example, the volatile memory may include static random-access memory (SRAM), dynamic random-access memory (DRAM), cache memory (e.g., Level 1 (L1) cache memory, Level 2 (L2) cache memory, Level 3 (L3) cache memory, etc.), etc., and/or any combination(s) thereof. In some examples, the non-volatile memory may include Flash memory, electrically erasable programmable read-only memory (EEPROM), magnetoresistive random-access memory (MRAM), ferroelectric random-access memory (FeRAM, F-RAM, or FRAM), etc., and/or any combination(s) thereof.

The electronic platform 1100 includes input device(s) 1112 to enable data and/or commands to be entered into the processor circuitry 1102. For example, the input device(s) 1112 may include an audio sensor, a camera (e.g., a still camera, a video camera, etc.), a keyboard, a microphone, a mouse, a touchscreen, a voice recognition system, etc., and/or any combination(s) thereof.

The electronic platform 1100 includes output device(s) 1114 to convey, display, and/or present information to a user (e.g., a human user, a machine user, etc.). For example, the output device(s) 1114 may include one or more display devices, speakers, etc. The one or more display devices may include an augmented reality (AR) and/or virtual reality (VR) display, a liquid crystal display (LCD), a light-emitting diode (LED) display, an organic light-emitting diode (OLED) display, a quantum dot (QLED) display, a thin-film transistor (TFT) LCD, a touchscreen, etc., and/or any combination(s) thereof. The output device(s) 1114 can be used, among other things, to generate, launch, and/or present a user interface. For example, the user interface may be generated and/or implemented by the output device(s) 1114 for visual presentation of output and speakers or other sound generating devices for audible presentation of output.

The electronic platform 1100 includes accelerators 1116, which are hardware devices to which the processor circuitry 1102 may offload compute tasks to accelerate their processing. For example, the accelerators 1116 may include artificial intelligence/machine-learning (AI/ML) processors, ASICs, FPGAs, graphics processing units (GPUs), neural network (NN) processors, systems-on-chip (SoCs), vision processing units (VPUs), etc., and/or any combination(s) thereof. In some examples, one or more of the wireless signal cancellation module 106, the adaptive beamforming module 136, and/or the data processing module 142 may be implemented by one(s) of the accelerators 1116 instead of the processor circuitry 1102. In some examples, the wireless signal cancellation module 106, the adaptive beamforming module 136, and/or the data processing module 142 may be executed concurrently (e.g., in parallel, substantially in parallel, etc.) by the processor circuitry 1102 and the accelerators 1116. For example, the processor circuitry 1102 and one(s) of the accelerators 1116 may execute in parallel function(s) corresponding to the wireless signal cancellation module 106.

The electronic platform 1100 includes storage 1118 to record and/or control access to data, such as the machine-readable instructions 1106. The storage 1118 may be implemented by one or more mass storage disks or devices, such as HDDs, SSDs, etc., and/or any combination(s) thereof.

The electronic platform 1100 includes interface(s) 1120 to effectuate exchange of data with external devices (e.g., computing and/or electronic devices of any kind) via a network 1122. In this example, the interface(s) 1120 implement(s) the antennas 112 of FIG. 1 and/or, more generally, the phased array 114 of FIG. 1. The interface(s) 1120 of the illustrated example may be implemented by an interface device, such as network interface circuitry (e.g., a NIC, a smart NIC, etc.), a gateway, a router, a switch, etc., and/or any combination(s) thereof. The interface(s) 1120 may implement any type of communication interface, such as a radar interface, BLUETOOTH®, a cellular telephone system (e.g., a 4G LTE interface, a 5G interface, a future generation 6G interface, etc.), an Ethernet interface, a near-field communication (NFC) interface, an optical disc interface (e.g., a Blu-ray disc drive, a Compact Disk (CD) drive, a Digital Versatile Disk (DVD) drive, etc.), an optical fiber interface, a satellite interface (e.g., a BLOS satellite interface, a LOS satellite interface, etc.), a Universal Serial Bus (USB) interface (e.g., USB Type-A, USB Type-B, USB TYPE-C™ or USB-C™, etc.), etc., and/or any combination(s) thereof.

The electronic platform 1100 includes a power supply 1124 to store energy and provide power to components of the electronic platform 1100. The power supply 1124 may be implemented by a power converter, such as an alternating current-to-direct-current (AC/DC) power converter, a direct current-to-direct current (DC/DC) power converter, etc., and/or any combination(s) thereof. For example, the power supply 1124 may be powered by an external power source, such as an alternating current (AC) power source (e.g., an electrical grid), a direct current (DC) power source (e.g., a battery, a battery backup system, etc.), etc., and the power supply 1124 may convert the AC input or the DC input into a suitable voltage for use by the electronic platform 1100. In some examples, the power supply 1124 may be a limited duration power source, such as a battery (e.g., a rechargeable battery such as a lithium-ion battery).

Component(s) of the electronic platform 1100 may be in communication with one(s) of each other via a bus 1126. For example, the bus 1126 may be any type of computing and/or electrical bus, such as an I2C bus, a PCI bus, a PCIe bus, a SPI bus, and/or the like.

The network 1122 may be implemented by any wired and/or wireless network(s) such as one or more cellular networks (e.g., 4G LTE cellular networks, 5G cellular networks, future generation 6G cellular networks, etc.), one or more data buses, one or more local area networks (LANs), one or more optical fiber networks, one or more private networks, one or more public networks, one or more wireless local area networks (WLANs), etc., and/or any combination(s) thereof. For example, the network 1122 may be the Internet, but any other type of private and/or public network is contemplated.

The network 1122 of the illustrated example facilitates communication between the interface(s) 1120 and a central facility 1128. The central facility 1128 in this example may be an entity associated with one or more servers, such as one or more physical hardware servers and/or virtualizations of the one or more physical hardware servers. For example, the central facility 1128 may be implemented by a public cloud provider, a private cloud provider, etc., and/or any combination(s) thereof. In this example, the central facility 1128 may compile, generate, update, etc., the machine-readable instructions 1106 and store the machine-readable instructions 1106 for access (e.g., download) via the network 1122. For example, the electronic platform 1100 may transmit a request, via the interface(s) 1120, to the central facility 1128 for the machine-readable instructions 1106 and receive the machine-readable instructions 1106 from the central facility 1128 via the network 1122 in response to the request.

Additionally or alternatively, the interface(s) 1120 may receive the machine-readable instructions 1106 via non-transitory machine-readable storage media, such as an optical disc 1130 (e.g., a Blu-ray disc, a CD, a DVD, etc.) or any other type of removable non-transitory machine-readable storage media such as a USB drive 1132. For example, the optical disc 1130 and/or the USB drive 1132 may store the machine-readable instructions 1106 thereon and provide the machine-readable instructions 1106 to the electronic platform 1100 via the interface(s) 1120.

Techniques operating according to the principles described herein may be implemented in any suitable manner. The processing and decision blocks of the flowcharts above represent steps and acts that may be included in algorithms that carry out these various processes. Algorithms derived from these processes may be implemented as software integrated with and directing the operation of one or more single- or multi-purpose processors, may be implemented as functionally equivalent circuits such as a DSP circuit or an ASIC, or may be implemented in any other suitable manner. It should be appreciated that the flowcharts included herein do not depict the syntax or operation of any particular circuit or of any particular programming language or type of programming language. Rather, the flowcharts illustrate the functional information one skilled in the art may use to fabricate circuits or to implement computer software algorithms to perform the processing of a particular apparatus carrying out the types of techniques described herein. For example, the flowcharts, or portion(s) thereof, may be implemented by hardware alone (e.g., one or more analog or digital circuits, one or more hardware-implemented state machines, etc., and/or any combination(s) thereof) that is configured or structured to carry out the various processes of the flowcharts. In some examples, the flowcharts, or portion(s) thereof, may be implemented by machine-executable instructions (e.g., machine-readable instructions, computer-readable instructions, computer-executable instructions, etc.) that, when executed by one or more single- or multi-purpose processors, carry out the various processes of the flowcharts. It should also be appreciated that, unless otherwise indicated herein, the particular sequence of steps and/or acts described in each flowchart is merely illustrative of the algorithms that may be implemented and can be varied in implementations and embodiments of the principles described herein.

Accordingly, in some embodiments, the techniques described herein may be embodied in machine-executable instructions implemented as software, including as application software, system software, firmware, middleware, embedded code, or any other suitable type of computer code. Such machine-executable instructions may be generated, written, etc., using any of a number of suitable programming languages and/or programming or scripting tools, and also may be compiled as executable machine language code or intermediate code that is executed on a framework, virtual machine, or container.

When techniques described herein are embodied as machine-executable instructions, these machine-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc., that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement using the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (e.g., as a single unit or separate units), or some of these functional facilities may not be implemented.

Machine-executable instructions (e.g., processor-executable instructions) implementing the techniques described herein (when implemented as one or more functional facilities or in any other manner) may, in some embodiments, be encoded on one or more computer-readable media, machine-readable media, etc., to provide functionality to the media. Computer-readable media, machine-readable media, etc., include magnetic media such as a hard disk drive, optical media such as a CD or a DVD, a persistent or non-persistent solid-state memory (e.g., Flash memory, Magnetic RAM, etc.), or any other suitable storage media. Such a computer-readable medium, a machine-readable medium, etc., may be implemented in any suitable manner. As used herein, the terms “computer-readable media” (also called “computer-readable storage media”), “computer-readable medium” (also called “computer-readable storage medium”), “machine-readable media” (also called “machine-readable storage media”), and “machine-readable medium” (also called “machine-readable storage medium”) refer to tangible storage media. Tangible storage media are non-transitory and have at least one physical, structural component. In a “computer-readable medium” and “machine-readable medium” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium, a machine-readable medium, etc., may be altered during a recording process.

Further, some techniques described above comprise acts of storing information (e.g., data and/or instructions) in certain ways for use by these techniques. In some implementations of these techniques—such as implementations where the techniques are implemented as machine-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as machine-executable instructions, these instructions may be executed on one or more suitable computing device(s) and/or electronic device(s) operating in any suitable computer and/or electronic system, or one or more computing devices (or one or more processors of one or more computing devices) and/or one or more electronic devices (or one or more processors of one or more electronic devices) may be programmed to execute the machine-executable instructions. A computing device, electronic device, or processor (e.g., processor circuitry) may be programmed to execute instructions when the instructions are stored in a manner accessible to the computing device, electronic device, or processor, such as in a data store (e.g., an on-chip cache or instruction register, a computer-readable storage medium and/or a machine-readable storage medium accessible via a bus, a computer-readable storage medium and/or a machine-readable storage medium accessible via one or more networks and accessible by the device/processor, etc.). Functional facilities comprising these machine-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more FPGAs for carrying out the techniques described herein, or any other suitable system.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc., described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

1. A method for reducing cellular interference in wireless communication signals, comprising:
receiving a wireless signal on a plurality of antennas at a wireless receiver;
detecting an allocation and modulation of data carrying and reference signal components of the wireless signal on resources of the plurality of antennas, the resources comprising at least one of time, frequency, or spatial resources of the plurality of antennas;
detecting a received symbol in the wireless signal based on the detected allocation and modulation;
reconstructing, using the received symbol, a denoised symbol representing an estimate of a contribution of an interferer signal at the wireless receiver, the contribution of the interferer signal isolated from all other sources;
subtracting the denoised symbol from the received symbol on an antenna-by-antenna basis to generate a residual wireless signal; and
outputting the residual wireless signal.

2. The method of claim 1, wherein the wireless signal is a time-domain waveform, the received symbol is an orthogonal frequency-division multiplexing (OFDM) symbol comprising a primary synchronization signal (PSS), and detecting the received symbol comprises:
sampling the time-domain waveform to generate time-domain samples;
calculating a plurality of synchronization detection parameters for the time-domain samples, each of the plurality of synchronization detection parameters associated with a different known sequence for the PSS;
determining that one of the plurality of synchronization detection parameters corresponds to one of the known PSS sequences; and
detecting the OFDM symbol comprising the PSS in accordance with the determined PSS sequence.

3. The method of claim 2, further comprising determining a cell ID sector parameter using the plurality of synchronization detection parameters.

4. The method of claim 2, wherein the OFDM symbol is a first OFDM symbol, and further comprising:
determining a location of a signal synchronization block (SSB) relative to a temporal resource grid boundary; and
detecting physical broadcast channel (PBCH) signal components of the SSB in accordance with the temporal resource grid boundary.

5. The method of claim 1, wherein the wireless signal is a time-domain waveform, the received symbol is an orthogonal frequency-division multiplexing (OFDM) symbol comprising a secondary synchronization signal (SSS), and detecting the received symbol comprises:
sampling the time-domain waveform to generate time-domain samples;
calculating a plurality of synchronization detection parameters for the time-domain samples, each of the plurality of synchronization detection parameters associated with a different known sequence for the SSS;
determining that one of the plurality of synchronization detection parameters corresponds to one of the known SSS sequences; and
detecting the OFDM symbol comprising the SSS in accordance with the determined SSS sequence.

6. The method of claim 5, further comprising:
determining, using the plurality of synchronization detection parameters, a cell ID sector parameter;
determining, using the determined SSS sequence, a cell ID group parameter; and
determining, using the cell ID sector parameter and the cell ID group parameter, a cell ID parameter.

7. The method of claim 1, wherein at least a portion of the wireless signal is a cellular communication signal associated with a fifth generation mobile network (5G).

8. The method of claim 1, wherein the received symbol is an orthogonal frequency-division multiplexing (OFDM) symbol comprising a primary synchronization signal (PSS), and generating the residual wireless signal comprises:
detecting the OFDM symbol comprising the PSS in the received wireless signal;
reconstructing a denoised PSS based on the received wireless signal; and
subtracting the denoised PSS from its corresponding OFDM symbol on an antenna-by-antenna basis to generate the residual wireless signal.

9. The method of claim 1, wherein the received symbol is an orthogonal frequency-division multiplexing (OFDM) symbol comprising a secondary synchronization signal (SSS), and generating the residual wireless signal comprises:
detecting the OFDM symbol comprising the SSS in the received wireless signal;
reconstructing a denoised SSS based on the received wireless signal; and
subtracting the denoised SSS from its corresponding OFDM symbol on an antenna-by-antenna basis to generate the residual wireless signal.

10. The method of claim 1, wherein the received symbol is an orthogonal frequency-division multiplexing (OFDM) symbol comprising a physical broadcast channel (PBCH).

11. The method of claim 1, wherein detecting the received symbol comprises:
detecting a full orthogonal frequency-division multiplexing (OFDM) resource grid boundary in temporal and spectral dimensions in accordance with at least one of a received primary synchronization signal (PSS), secondary synchronization signal (SSS), or physical broadcast channel (PBCH);
identifying one or more occupied OFDM resource blocks within the resource grid boundary associated with the interferer signal;
detecting a demodulation reference signal (DMRS) configuration for each of the one or more occupied OFDM resource blocks, the DMRS configuration detected from a set of candidate DMRS configurations; and
identifying each of the one or more occupied OFDM resource blocks as either a physical data shared channel (PDSCH) or a physical downlink control channel (PDCCH).

12. The method of claim 11, further comprising:
determining, using the DMRS, a channel estimate as a function of time and frequency;
equalizing, using the channel estimate, the received resource blocks;
detecting the modulation of the equalized resource blocks; and
demodulating the one or more occupied OFDM resource blocks to generate a demodulated symbol.

13. The method of claim 12, wherein:
reconstructing the denoised symbol comprises applying the channel estimate to the demodulated symbol to generate a reconstructed symbol; and
subtracting the denoised symbol from the received symbol comprises subtracting the reconstructed symbol from the received symbol to generate the residual wireless signal.

14. At least one computer-readable storage medium storing processor-executable instructions that, when executed by at least one hardware processor, cause the at least one hardware processor to perform a method for reducing interference in wireless communication signals, the method comprising:
receiving a wireless signal on a plurality of antennas at a wireless receiver;
detecting an allocation and modulation of data carrying and reference signal components of the wireless signal on resources of the plurality of antennas, the resources comprising at least one of time, frequency, or spatial resources of the plurality of antennas;
detecting a received symbol in the wireless signal based on the detected allocation and modulation;
reconstructing, using the received symbol, a denoised symbol representing an estimate of a contribution of an interferer signal at the wireless receiver, the contribution of the interferer signal isolated from all other sources;
subtracting the denoised symbol from the received symbol on an antenna-by-antenna basis to generate a residual wireless signal; and
outputting the residual wireless signal.

15. The at least one computer-readable storage medium of claim 14, wherein the wireless signal is a time-domain waveform, the received symbol is an orthogonal frequency-division multiplexing (OFDM) symbol comprising a primary synchronization signal (PSS), and detecting the received symbol comprises:
sampling the time-domain waveform to generate time-domain samples;
calculating a plurality of synchronization detection parameters for the time-domain samples, each of the plurality of synchronization detection parameters associated with a different known sequence for the PSS;
determining that one of the plurality of synchronization detection parameters corresponds to one of the known PSS sequences; and
detecting the OFDM symbol comprising the PSS in accordance with the determined PSS sequence.

16. The at least one computer-readable storage medium of claim 15, wherein the instructions further cause the at least one hardware processor to determine a cell ID sector parameter using the plurality of synchronization detection parameters.

17. The at least one computer-readable storage medium of claim 15, wherein the OFDM symbol is a first OFDM symbol, and the instructions further cause the at least one hardware processor to:
determine a location of a signal synchronization block (SSB) relative to a temporal resource grid boundary; and
detect physical broadcast channel (PBCH) signal components of the SSB in accordance with the temporal resource grid boundary.

18. A system for reducing interference in wireless communication signals, the system comprising:
at least one hardware processor; and
at least one computer-readable storage medium storing processor-executable instructions that, when executed by the at least one hardware processor, cause the at least one hardware processor to perform a method comprising:
receiving a wireless signal on a plurality of antennas at a wireless receiver;
detecting an allocation and modulation of data carrying and reference signal components of the wireless signal on resources of the plurality of antennas, the resources comprising at least one of time, frequency, or spatial resources of the plurality of antennas;
detecting a received symbol in the wireless signal based on the detected allocation and modulation;
reconstructing, using the received symbol, a denoised symbol representing an estimate of a contribution of an interferer signal at the wireless receiver, the contribution of the interferer signal isolated from all other sources;
subtracting the denoised symbol from the received symbol on an antenna-by-antenna basis to generate a residual wireless signal; and
outputting the residual wireless signal.

19. The system of claim 18, wherein detecting the received symbol comprises:
identifying one or more occupied orthogonal frequency-division multiplexing (OFDM) resource blocks associated with the interferer signal;
detecting a demodulation reference signal (DMRS) configuration for each of the one or more occupied OFDM resource blocks, the DMRS configuration detected from a set of candidate DMRS configurations; and
identifying each of the one or more occupied OFDM resource blocks as either a physical data shared channel (PDSCH) or a physical downlink control channel (PDCCH).

20. The system of claim 19, further comprising:
determining, using the DMRS, a channel estimate as a function of time and frequency;
equalizing, using the channel estimate, the received resource blocks;
detecting the modulation of the equalized resource blocks; and
demodulating the one or more occupied OFDM resource blocks to generate a demodulated symbol; and wherein:
reconstructing the denoised symbol comprises applying the channel estimate to the demodulated symbol to generate a reconstructed symbol; and
subtracting the denoised symbol from the received symbol comprises subtracting the reconstructed symbol from the received symbol to generate the residual wireless signal.
